(19) United States
(12) Patent Application Publication
(10) Pub. No.: US 2023/0254773 A1
(43) Pub. Date: Aug. 10, 2023

(54) POWER CONTROL FOR CHANNEL STATE FEEDBACK PROCESSING

(71) Applicant: QUALCOMM Incorporated, San Diego, CA (US)

(72) Inventors: Pavan Kumar VITTHALADEVUNI, San Diego, CA (US); Alexandros MANOLAKOS, Escondido, CA (US); Taesang YOO, San Diego, CA (US); Naga BHUSHAN, San Diego, CA (US); June NAMGOONG, San Diego, CA (US); Jay Kumar SUNDARARAJAN, San Diego, CA (US); Krishna Kiran MUKKAVILLI, San Diego, CA (US); Wanshi CHEN, San Diego, CA (US); Tingfang JI, San Diego, CA (US)

(21) Appl. No.: 18/003,059

(22) PCT Filed: Aug. 13, 2021
(86) PCT No.: PCT/US2021/071189

§ 371 Date: Dec. 22, 2022

(30) Foreign Application Priority Data
Aug. 18, 2020 (GR) 20200100492

(51) Int. Cl. H04W 52/02; H04B 7/06

(52) U.S. Cl. CPC H04W 52/0261; H04B 7/0626; H04B 7/0641

(57) ABSTRACT

Various aspects of the present disclosure generally relate to wireless communication. In some aspects, a first device may determine that a power threshold for the first device is satisfied. The first device may transition from a first type of channel state feedback processing to a second type of channel state feedback processing based at least in part on determining that the power threshold for the first device is satisfied.

### CROSS-REFERENCE TO RELAYED APPLICATION

This Patent Application claims priority to Greece Patent Application No. 20200100492, filed on Aug. 18, 2020, entitled “POWER CONTROL FOR CHANNEL STATES FEEDBACK PROCESSING,” and assigned to the assignee hereof. The disclosure of the prior Application is considered part of and is incorporated by reference into this Patent Application.

### INTRODUCTION

Aspects of the present disclosure generally relate to wireless communication and to techniques and apparatuses for channel state information processing.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in L IL, NR, and other radio access technologies remain useful.

### SUMMARY

In some aspects, a method of wireless communication performed by a first device includes determining that a power threshold for the first device is satisfied. The method includes transitioning from a first type of channel state feedback processing to a second type of channel state feedback processing based at least in part on determining that the power threshold for the first device is satisfied.

In some aspects, a first device for wireless communication includes: a memory; and one or more processors coupled to the memory, the one or more processors configured to determine that a power threshold for the first device is satisfied. The one or more processors are configured to transition from a first type of channel state feedback processing to a second type of channel state feedback processing based at least in part on determining that the power threshold for the first device is satisfied.

In some aspects, a non-transitory computer-readable medium storing a set of instructions for wireless communication includes one or more instructions that, when executed by one or more processors of a first device, cause the first device to determine that a power threshold for the first device is satisfied and transition from a first type of channel state feedback processing to a second type of channel state feedback processing based at least in part on determining that the power threshold for the first device is satisfied.

In some aspects, an apparatus for wireless communication includes means for determining that a power threshold for the apparatus is satisfied. The apparatus may include means for transitioning from a first type of channel state feedback processing to a second type of channel state feedback processing based at least in part on determining that the power threshold for the apparatus is satisfied.

In some aspects, a method of wireless communication performed by a second device includes receiving first channel state feedback processed using a first type of channel state feedback processing. The method includes receiving, after satisfaction of a power threshold, second channel state feedback processed using a second type of channel state feedback processing.

In some aspects, a second device for wireless communication includes a memory; and one or more processors coupled to the memory, the one or more processors configured to receive first channel state feedback processed using a first type of channel state feedback processing. The one or more processors may be configured to receive, after satisfaction of a power threshold, second channel state feedback processed using a second type of channel state feedback processing.

In some aspects, a non-transitory computer-readable medium storing a set of instructions for wireless communication includes one or more instructions that, when executed by one or more processors of a second device, cause the second device to receive first channel state feedback processed using a first type of channel state feedback processing and receive, after satisfaction of a power threshold, second channel state feedback processed using a second type of channel state feedback processing.

In some aspects, an apparatus for wireless communication includes means for receiving first channel state feedback processed using a first type of channel state feedback processing. The apparatus includes means for receiving, after satisfaction of a power threshold, second channel state feedback processed using a second type of channel state feedback processing.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an encoder and a decoder that use previously stored channel state information, in accordance with the present disclosure.

FIG. 4 is a diagram illustrating an example of an encoding device and a decoding device, in accordance with the present disclosure.

FIGS. 5-8 are diagrams illustrating examples of encoding and decoding a data set using a neural network for uplink communication, in accordance with the present disclosure.

FIG. 9 is a diagram illustrating an example associated with power control for channel state feedback processing, in accordance with the present disclosure.

FIG. 10 is a diagram illustrating an example process associated with power control for channel state feedback processing, in accordance with the present disclosure.

FIGS. 11-13 are diagrams illustrating example apparatuses, in accordance with the present disclosure.

FIGS. 14-15 are diagrams illustrating examples of channel state feedback processing, in accordance with the present disclosure.

FIG. 16 is a diagram illustrating an example process associated with power control for channel state feedback processing, in accordance with the present disclosure.

FIGS. 17-19 are diagrams illustrating example apparatuses, in accordance with the present disclosure.

### DETAILED DESCRIPTION

An encoding device operating in a network may measure reference signals and/or the like to report to a network entity. For example, the encoding device may measure reference signals during a beam management process for channel state feedback (CSF), may measure received power of reference signals from a serving cell and/or neighbor cells, may measure signal strength of inter-radio access technology (e.g., WiFi) networks, may measure sensor signals for detecting locations of one or more objects within an environment, and/or the like. However, reporting this information to the base station may consume communication and/or network resources.

Thus, an encoding device (e.g., a UE, a base station, a transmit receive point (TRP), a network device, a low-earth orbit (LEO) satellite, a medium-earth orbit (MEO) satellite, a geostationary earth orbit (GEO) satellite, a high elliptical orbit (HEO) satellite, and/or the like) may train one or more neural networks to learn dependence of measured qualities on individual parameters, isolate the measured qualities through various layers of the one or more neural networks (also referred to as “operations”), and compress measurements in a way that limits compression loss. In some aspects, the encoding device may use a nature of a quantity of bits being compressed to construct a process of extraction and compression of each feature (also referred to as a dimension) that affects the quantity of bits. In some aspects, the quantity of bits may be associated with sampling of one or more reference signals and/or may indicate channel state information. For example, the encoding device may encode measurements, to produce compressed measurements, using one or more extraction operations and compression operations associated with a neural network with the one or more extraction operations and compression operations being based at least in part on a set of features of the measurements.

The encoding device may transmit the compressed measurements to a network entity, such as server, a TRP, another UE, a base station, and/or the like. Although examples described herein refer to a base station as the decoding device, the decoding device may be any network entity. The network entity may be referred to as a “decoding device.”

The decoding device may decode the compressed measurements using one or more decompression operations and reconstruction operations associated with a neural network. The one or more decompression and reconstruction operations may be based at least in part on a set of features of the compressed data set to produce reconstructed measurements. The decoding device may use the reconstructed measurements as channel state information feedback.

An encoding device, such as a UE, may be configured to use a plurality of different processing types for processing channel state feedback. For example, a UE may use a first type of neural network to process channel state information with compressed measurements, a second type of neural network to process channel state information with compressed measurements, among other examples described above. Further, the UE may use a non-neural-network-based technique to process channel state information (without compression or with less compression than other techniques). Such types of processing techniques may achieve transmission of enhanced levels of channel state feedback without causing excessive network overhead. However, in some scenarios, the UE may have limited resources, such as power resources or processing resources, for processing channel state feedback.

Some aspects described herein enable a UE to dynamically adjust which type of channel state feedback processing the UE performs to account for limited resources. For example, when a UE detects less than a threshold battery level, the UE may switch from a first type of neural network to a second type of neural network. In one or more examples, processing using the second type of neural network may be associated with less power consumption than processing using the first type of neural network, thereby enabling the UE to preserve battery resources. Similarly, when the UE detects that other functionalities are using more than a threshold amount of processing resources, the UE may switch from neural network-based processing to non-neural-network-based processing (which may be associated with reduced utilization of processing resources than neural network-based processing) of channel state feedback.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

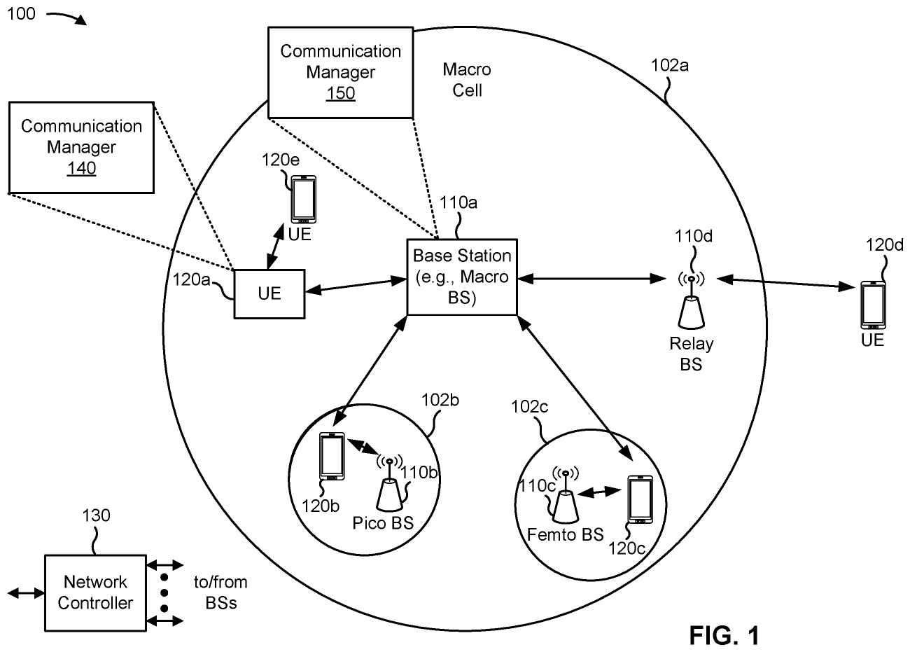

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a TRP. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first device (e.g., a UE 120) may include a communication manager 140. As described in more detail elsewhere herein, the communication manager 140 may determine that a power threshold for the first device is satisfied; and transition from a first type of channel state feedback processing to a second type of channel state feedback processing based at least in part on determining that the power threshold for the first device is satisfied. Additionally, or alternatively, the communication manager 140 may perform one or more other operations described herein.

In some aspects, a second device (e.g., a base station 110) may include a communication manager 150. As described in more detail elsewhere herein, the communication manager 150 may receive first channel state feedback processed using a first type of channel state feedback processing; and receive , after satisfaction of a power threshold, second channel state feedback processed using a second type of channel state feedback processing. Additionally, or alternatively, the communication manager 150 may perform one or more other operations described herein.

As indicated above, FIG. 1 is provided as an example. Other examples may differ from what is described with regard to FIG. 1.

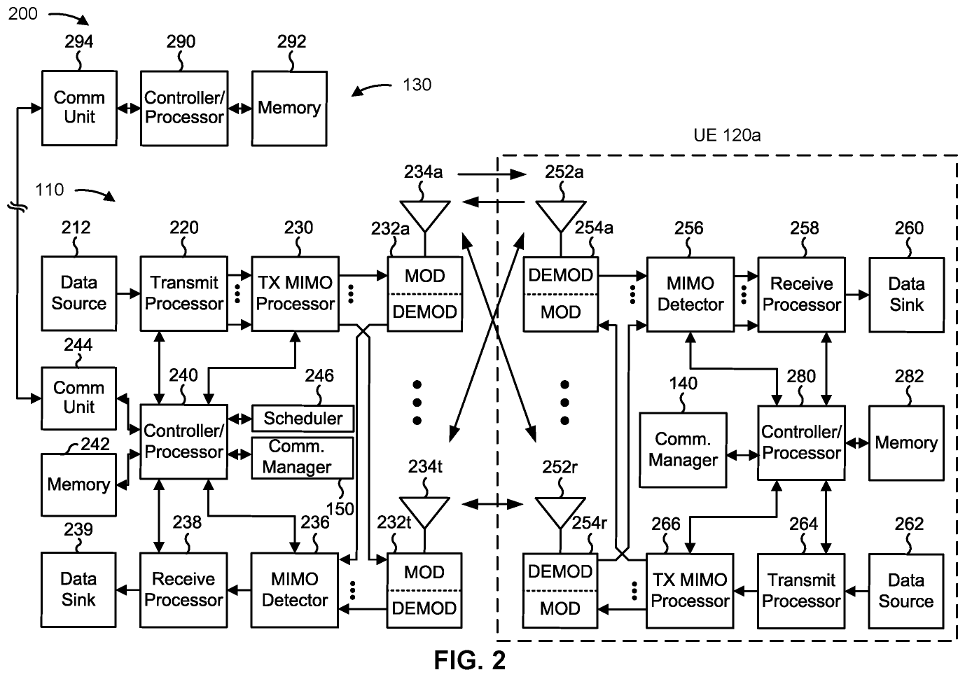

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

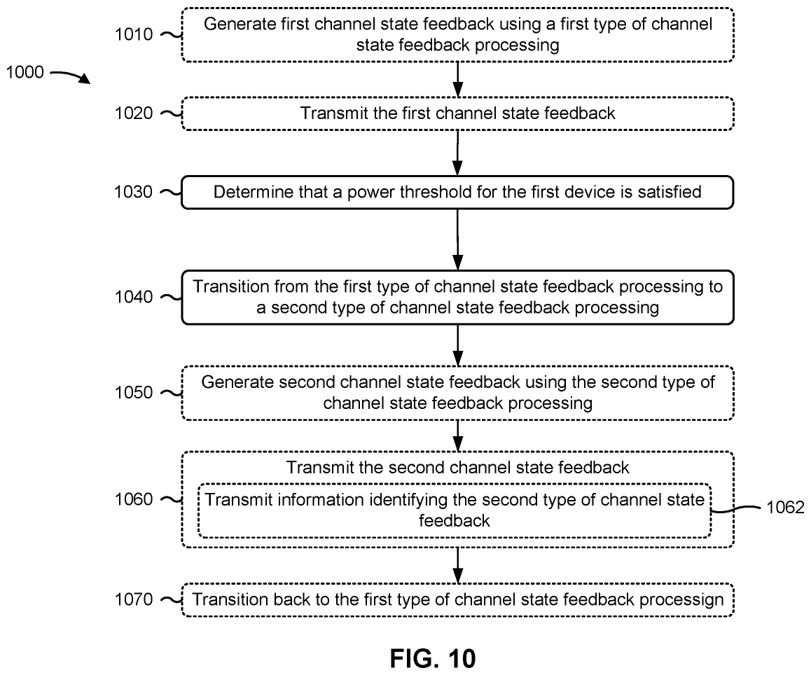

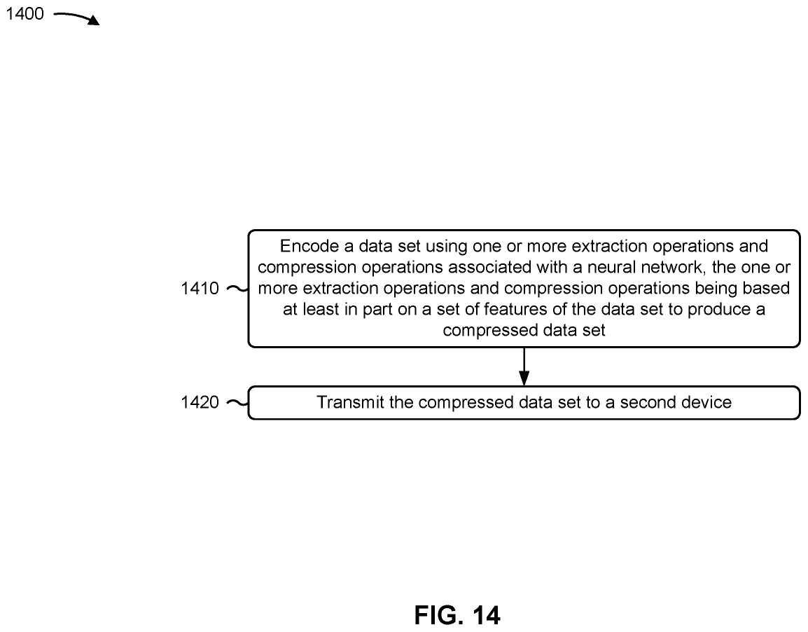

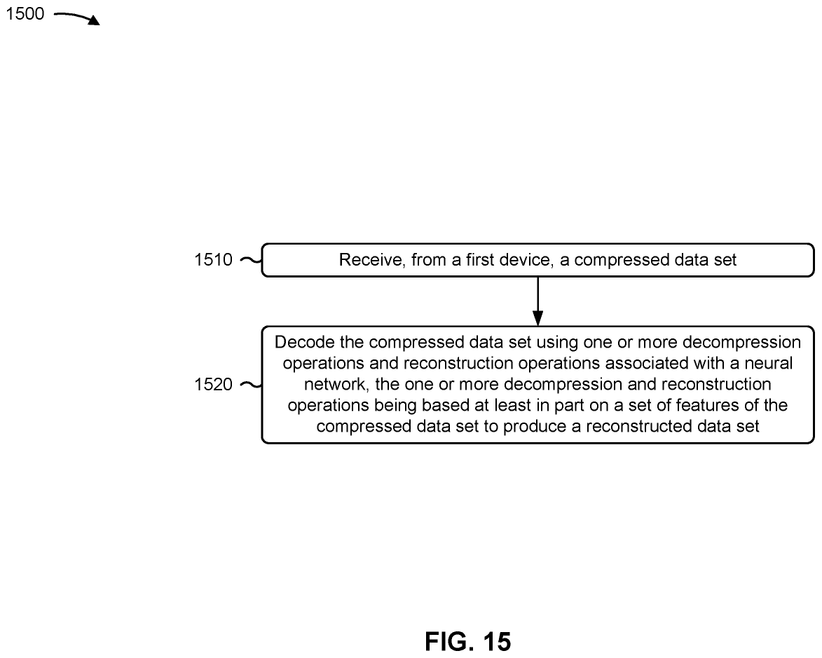

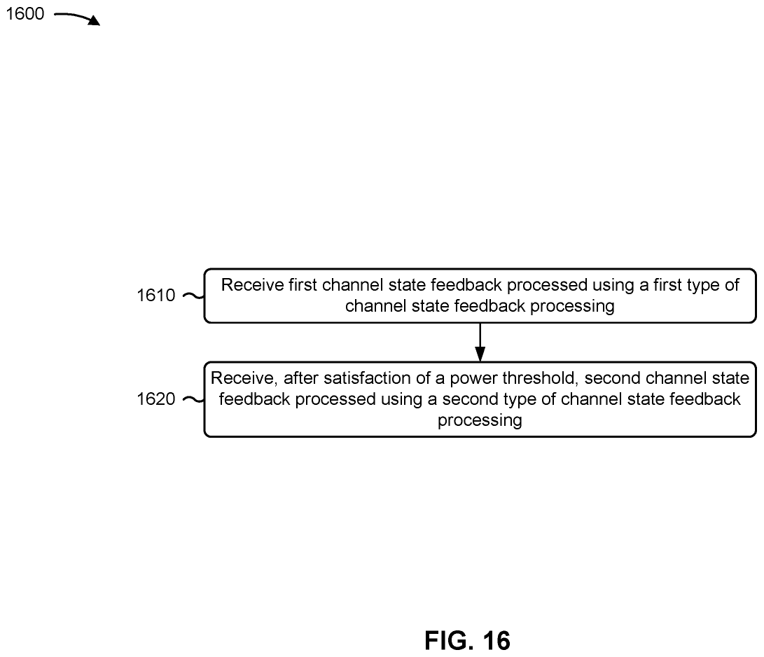

The controller/processor 240 of the base station 110, the controller/processor 280 of the UE 120, and/or any other component(s) of FIG. 2 may perform one or more techniques associated with power control for channel state feedback processing, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1400 of FIG. 14, process 1500 of FIG. 15, process 1600 of FIG. 16, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1400 of FIG. 14, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, the UE 120a may include means for determining that a power threshold for the UE is satisfied, means for transitioning from a first type of channel state feedback processing to a second type of channel state feedback processing based at least in part on determining that the power threshold for the UE is satisfied, and/or the like. Additionally, or alternatively, the UE 120a may include means for performing one or more other operations described herein. In some aspects, such means may include the communication manager 140. Additionally, or alternatively, such means may include one or more other components of the UE 120a described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, the base station 110 may include means for receiving first channel state feedback processed using a first type of channel state feedback processing, means for receiving, after satisfaction of a power threshold, second channel state feedback processed using a second type of channel state feedback processing, and/or the like. Additionally, or alternatively, the base station 110 may include means for performing one or more other operations described herein. In some aspects, such means may include the communication manager 150. Additionally, or alternatively, such means may include one or more other components of the base station 110 described in connection with FIG. 2, such as controller/processor 240, transmit processor 220, TX MIMO processor 230, MOD 232, antenna 234, DEMOD 232, MIMO detector 236, receive processor 238, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

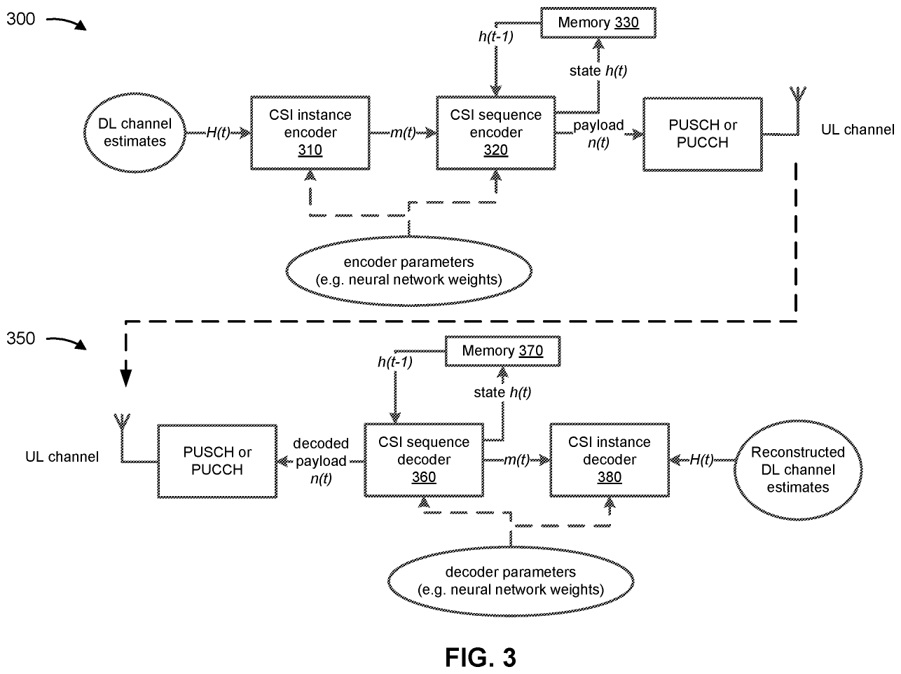

FIG. 3 illustrates an example of an encoding device 300 and a decoding device 350 that use previously stored channel state information (CSI), in accordance with the present disclosure. FIG. 3 shows the encoding device 300 (e.g., UE 120) with a CSI instance encoder 310, a CSI sequence encoder 320, and a memory 330. FIG. 3 also shows the decoding device 350 (e.g., base station 110) with a CSI sequence decoder 360, a memory 370, and a CSI instance decoder 380.

The encoding device 300 and the decoding device 350 may take advantage of a correlation of CSI instances over time (temporal aspect), or over a sequence of CSI instances for a sequence of channel estimates. The encoding device 300 and the decoding device 350 may save and use previously stored CSI and encode and decode only a change in the CSI from a previous instance. This may provide for less CSI feedback overhead and improve performance. The encoding device 300 may also be able to encode more accurate CSI, and neural networks may be trained with more accurate CSI.

As shown in FIG. 3, CSI instance encoder 310 may encode a CSI instance into intermediate encoded CSI for each DL channel estimate in a sequence of DL channel estimates. CSI instance encoder 310 (e.g., a feedforward network) may use neural network encoder weights θ. The intermediate encoded CSI may be represented as m(t)\hat{=}ƒ_{enc,θ}(H(t)). CSI sequence encoder 320 (e.g., a Long Short-Term Memory (LSTM) network) may determine a previously encoded CSI instance h(t−1) from memory 330 and compare the intermediate encoded CSI m(t) and the previously encoded CSI instance h(t−1) to determine a change n(t) in the encoded CSI. The change n(t) may be a part of a channel estimate that is new and may not be predicted by the decoding device 350. The encoded CSI at this point may be represented by [n(t), h_{enc}(t)]\hat{=}g_{enc,θ}(m(t), h_{enc}(t−1)). CSI sequence encoder 320 may provide this change n(t) on the physical uplink shared channel (PUSCH) or the physical uplink control channel (PUCCH), and the encoding device 300 may transmit the change (e.g., information indicating the change) n(t) as the encoded CSI on the UL channel to the decoding device 350. Because the change is smaller than an entire CSI instance, the encoding device 300 may send a smaller payload for the encoded CSI on the UL channel, while including more detailed information in the encoded CSI for the change. CSI sequence encoder 320 may generate encoded CSI h(t) based at least in part on the intermediate encoded CSI m(t) and at least a portion of the previously encoded CSI instance h(t−1). CSI sequence encoder 320 may save the encoded CSI h(t) in memory 330.

CSI sequence decoder 360 may receive encoded CSI on the PUSCH or PUCCH. CSI sequence decoder 360 may determine that only the change n(t) of CSI is received as the encoded CSI. CSI sequence decoder 360 may determine an intermediate decoded CSI m(t) based at least in part on the encoded CSI and at least a portion of a previous intermediate decoded CSI instance h(t−1) from memory 370 and the change. CSI instance decoder 380 may decode the intermediate decoded CSI m(t) into decoded CSI. CSI sequence decoder 360 and CSI instance decoder 380 may use neural network decoder weights Φ. The intermediate decoded CSI may be represented by [\hat{m}(t), h_{dec}(t)]\hat{=}g_{dec,Φ}(n(t), h_{dec}(t−1)). CSI sequence decoder 360 may generate decoded CSI h(t) based at least in part on the intermediate decoded CSI m(t) and at least a portion of the previously decoded CSI instance h(t−1). The decoding device 350 may reconstruct a DL channel estimate from the decoded CSI h(t), and the reconstructed channel estimate may be represented as H\hat{ }(t)\hat{=}ƒ_(dec,Φ) (m\hat{ }(t)). CSI sequence decoder 360 may save the decoded CSI h(t) in memory 370.

Because the change n(t) is smaller than an entire CSI instance, the encoding device 300 may send a smaller payload on the UL channel. For example, if the DL channel has changed little from previous feedback, due to a low Doppler or little movement by the encoding device 300, an output of the CSI sequence encoder may be rather compact. In this way, the encoding device 300 may take advantage of a correlation of channel estimates over time. Because the output is small, the encoding device 300 may include more detailed information in the encoded CSI for the change. The encoding device 300 may transmit an indication (e.g., flag) to the decoding device 350 that the encoded CSI is temporally encoded (a CSI change). Alternatively, the encoding device 300 may transmit an indication that the encoded CSI is encoded independently of any previously encoded CSI feedback. The decoding device 350 may decode the encoded CSI without using a previously decoded CSI instance. A device, which may include the encoding device 300 or the decoding device 350, may train a neural network model using a CSI sequence encoder and a CSI sequence decoder.

CSI may be a function of a channel estimate (referred to as a channel response) H and interference N. There may be multiple ways to convey H and N. For example, the encoding device 300 may encode the CSI as N^{-1/2}H. The encoding device 300 may encode H and N separately. The encoding device 300 may partially encode H and N separately, and then jointly encode the two partially encoded outputs. Encoding H and N separately maybe advantageous. Interference and channel variations may happen on different time scales. In a low Doppler scenario, a channel may be steady but interference may still change faster due to traffic or scheduler algorithms. In a high Doppler scenario, the channel may change faster than a scheduler-grouping of UEs. In some aspects, a device, which may include the encoding device 300 or the decoding device 350, may train a neural network model using separately encoded H and N.

A reconstructed DL channel Ĥ may faithfully reflect the DL channel H, and this may be called explicit feedback. In some cases, Ĥ may capture only that information required for the decoding device 350 to derive rank and precoding. CQI may be fed back separately. CSI feedback may be expressed as m(t), or as n(t) in a scenario of temporal encoding. Similarly to Type-II CSI feedback, m(t) may be structured to be a concatenation of rank index (RI), beam indices, and coefficients representing amplitudes or phases. In some cases, m(t) may be a quantized version of a real-valued vector. Beams may be pre-defined (not obtained by training), or may be a part of the training (e.g., part of θ and Φ) and conveyed to the encoding device 300 or the decoding device 350).

The decoding device 350 and the encoding device 300 may maintain multiple encoder and decoder networks, each targeting a different payload size (for varying accuracy vs. UL overhead tradeoff). For each CSI feedback, depending on a reconstruction quality and an uplink budget (e.g., PUSCH payload size), the encoding device 300 may choose, or the decoding device 350 may instruct the encoding device 300 to choose, one of the encoders to construct the encoded CSI. The encoding device 300 may send an index of the encoder along with the CSI based at least in part on an encoder chosen by the encoding device 300. Similarly, the decoding device 350 and the encoding device 300 may maintain multiple encoder and decoder networks to cope with different antenna geometries and channel conditions. Note that while some operations are described for the decoding device 350 and the encoding device 300, these operations may also be performed by another device, as part of a preconfiguration of encoder and decoder weights and/or structures.

As indicated above, FIG. 3 may be provided as an example. Other examples may differ from what is described with regard to FIG. 3.

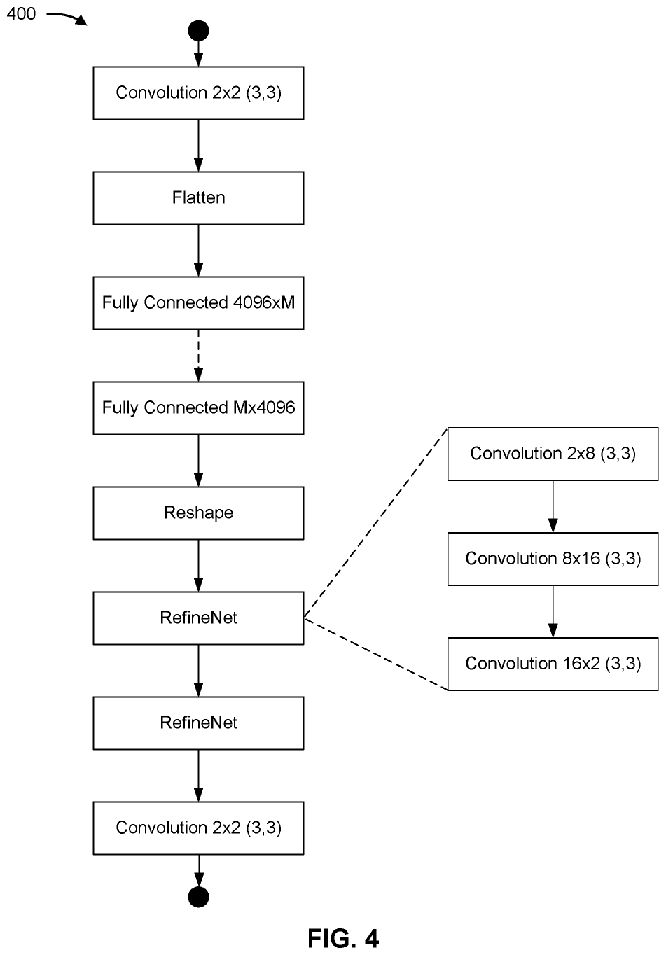

FIG. 4 is a diagram illustrating an example 400 associated with an encoding device and a decoding device, in accordance with the present disclosure. The encoding device (e.g., UE 120, encoding device 300, and/or the like) may be configured to perform one or more operations on data to compress the data. The decoding device (e.g., base station 110, decoding device 350, and/or the like) may be configured to decode the compressed data to determine information.

As used herein, a “layer” of a neural network is used to denote an operation on input data. For example, a convolution layer, a fully connected layer, and/or the like denote associated operations on data that is input into a layer. A convolution A×B operation refers to an operation that converts a number of input features A into a number of output features B. “Kernel size” refers to a number of adjacent coefficients that are combined in a dimension.

As used herein, “weight” is used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values.

As shown in example 400, the encoding device may perform a convolution operation on samples. For example, the encoding device may receive a set of bits structured as a 2×64×32 data set that indicates IQ sampling for tap features (e.g., associated with multipath timing offsets) and spatial features (e.g., associated with different antennas of the encoding device). The convolution operation may be a 2×2 operation with kernel sizes of 3 and 3 for the data structure. The output of the convolution operation may be input to a batch normalization (BN) layer followed by a LeakyReLU activation, giving an output data set having dimensions 2×64×32. The encoding device may perform a flattening operation to flatten the bits into a 4096 bit vector. The encoding device may apply a fully connected operation, having dimensions 4096×M, to the 4096 bit vector to output a payload of M bits. The encoding device may transmit the payload of M bits to the decoding device.

The decoding device may apply a fully connected operation, having dimensions M×4096, to the M bit payload to output a 4096 bit vector. The decoding device may reshape the 4096 bit vector to have dimension 2×64×32. The decoding device may apply one or more refinement network (RefineNet) operations on the reshaped bit vector. For example, a RefineNet operation may include application of a 2×8 convolution operation (e.g., with kernel sizes of 3 and 3) with output that is input to a BN layer followed by a LeakyReLU activation that produces an output data set having dimensions 8×64×32, application of an 8×16 convolution operation (e.g., with kernel sizes of 3 and 3) with output that is input to a BN layer followed by a LeakyReLU activation that produces an output data set having dimensions 16×64×32, and/or application of a 16×2 convolution operation (e.g., with kernel sizes of 3 and 3) with output that is input to a BN layer followed by a LeakyReLU activation that produces an output data set having dimensions 2×64×32. The decoding device may also apply a 2×2 convolution operation with kernel sizes of 3 and 3 to generate decoded and/or reconstructed output.

As indicated above, FIG. 4 is provided merely as an example. Other examples may differ from what is described with regard to FIG. 4.

As described herein, an encoding device operating in a network may measure reference signals and/or the like to report to a decoding device. For example, a UE may measure reference signals during a beam management process to report CSF, may measure received power of reference signals from a serving cell and/or neighbor cells, may measure signal strength of inter-radio access technology (e.g., WiFi) networks, may measure sensor signals for detecting locations of one or more objects within an environment, and/or the like. However, reporting this information to the network entity may consume communication and/or network resources.

An encoding device (e.g., a UE) may train one or more neural networks to learn dependence of measured qualities on individual parameters, isolate the measured qualities through various layers of the one or more neural networks (also referred to as “operations”), and compress measurements in a way that limits compression loss. The encoding device may use a nature of a quantity of bits being compressed to construct a process of extraction and compression of each feature (also referred to as a dimension) that affects the quantity of bits. The quantity of bits may be associated with sampling of one or more reference signals and/or may indicate channel state information.

Based at least in part on encoding and decoding a data set using a neural network for uplink communication, the encoding device may transmit CSF with a reduced payload. This may conserve network resources that may otherwise have been used to transmit a full data set as sampled by the encoding device.

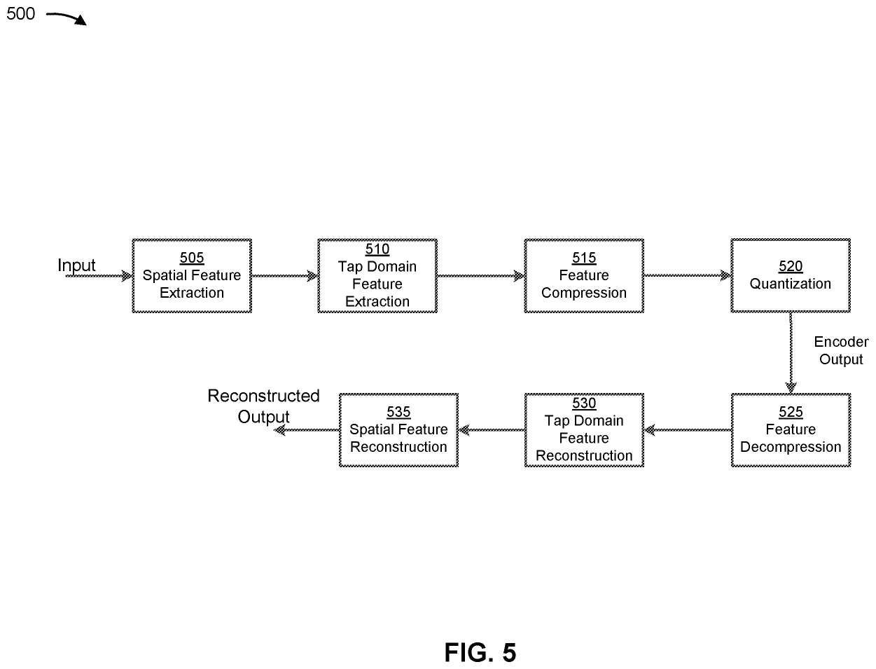

FIG. 5 is a diagram illustrating an example 500 associated with encoding and decoding a data set using a neural network for uplink communication, in accordance with the present disclosure. An encoding device (e.g., UE 120, encoding device 300, and/or the like) may be configured to perform one or more operations on samples (e.g., data) received via one or more antennas of the encoding device to compress the samples. A decoding device (e.g., base station 110, decoding device 350, and/or the like) may be configured to decode the compressed samples to determine information, such as CSF.

The encoding device may identify a feature to compress. The encoding device may perform a first type of operation in a first dimension associated with the feature to compress. The encoding device may perform a second type of operation in other dimensions (e.g., in all other dimensions). For example, the encoding device may perform a fully connected operation on the first dimension and convolution (e.g., pointwise convolution) in all other dimensions.

The reference numbers may identify operations that include multiple neural network layers and/or operations. Neural networks of the encoding device and the decoding device may be formed by concatenation of one or more of the referenced operations.

As shown by reference number 505, the encoding device may perform a spatial feature extraction on the data. As shown by reference number 510, the encoding device may perform a tap domain feature extraction on the data. The encoding device may perform the tap domain feature extraction before performing the spatial feature extraction. An extraction operation may include multiple operations. For example, the multiple operations may include one or more convolution operations, one or more fully connected operations, and/or the like, that may be activated or inactive. An extraction operation may include a residual neural network (ResNet) operation.

As shown by reference number 515, the encoding device may compress one or more features that have been extracted. A compression operation may include one or more operations, such as one or more convolution operations, one or more fully connected operations, and/or the like. After compression, a bit count of an output may be less than a bit count of an input.

As shown by reference number 520, the encoding device may perform a quantization operation. The encoding device may perform the quantization operation after flattening the output of the compression operation and/or performing a fully connected operation after flattening the output.

As shown by reference number 525, the decoding device may perform a feature decompression. As shown by reference number 530, the decoding device may perform a tap domain feature reconstruction. As shown by reference number 535, the decoding device may perform a spatial feature reconstruction. The decoding device may perform spatial feature reconstruction before performing tap domain feature reconstruction. After the reconstruction operations, the decoding device may output the reconstructed version of the encoding device's input.

The decoding device may perform operations in an order that is opposite to operations performed by the encoding device. For example, if the encoding device follows operations (a, b, c, d), the decoding device may follow inverse operations (D, C, B, A). The decoding device may perform operations that are fully symmetric to operations of the encoding device. This may reduce a number of bits needed for neural network configuration at the UE. The decoding device may perform additional operations (e.g., convolution operations, fully connected operation, ResNet operations, and/or the like) in addition to operations of the encoding device. The decoding device may perform operations that are asymmetric to operations of the encoding device.

Based at least in part on the encoding device encoding a data set using a neural network for uplink communication, the encoding device (e.g., a UE) may transmit CSF with a reduced payload. This may conserve network resources that may otherwise have been used to transmit a full data set as sampled by the encoding device.

As indicated above, FIG. 5 is provided merely as an example. Other examples may differ from what is described with regard to FIG. 5.

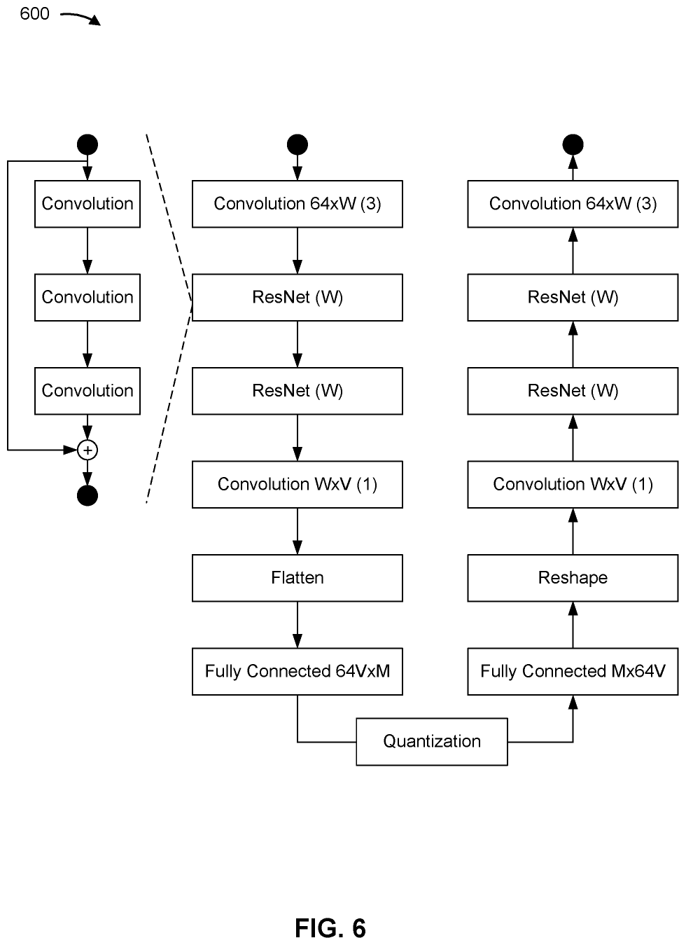

FIG. 6 is a diagram illustrating an example 600 associated with encoding and decoding a data set using a neural network for uplink communication, in accordance with the present disclosure. An encoding device (e.g., UE 120, encoding device 300, and/or the like) may be configured to perform one or more operations on samples (e.g., data) received via one or more antennas of the encoding device to compress the samples. A decoding device (e.g., base station 110, decoding device 350, and/or the like) may be configured to decode the compressed samples to determine information, such as CSF.

As shown by example 600, the encoding device may receive sampling from antennas. For example, the encoding device may receive a 64×64 dimension data set based at least in part on a number of antennas, a number of samples per antenna, and a tap feature.

The encoding device may perform a spatial feature extraction, a short temporal (tap) feature extraction, and/or the like. This may be accomplished through the use of a 1-dimensional convolutional operation, that is fully connected in the spatial dimension (to extract the spatial feature) and simple convolution with a small kernel size (e.g., 3) in the tap dimension (to extract the short tap feature). Output from such a 64×W 1-dimensional convolution operation may be a W×64 matrix.

The encoding device may perform one or more ResNet operations. The one or more ResNet operations may further refine the spatial feature and/or the temporal feature. A ResNet operation may include multiple operations associated with a feature. For example, a ResNet operation may include multiple (e.g., 3) 1-dimensional convolution operations, a skip connection (e.g., between input of the ResNet and output of the ResNet to avoid application of the 1-dimensional convolution operations), a summation operation of a path through the multiple 1-dimensional convolution operations and a path through the skip connection, and/or the like. The multiple 1-dimensional convolution operations may include a W×256 convolution operation with kernel size 3 with output that is input to a BN layer followed by a LeakyReLU activation that produces an output data set of dimension 256×64, a 256×512 convolution operation with kernel size 3 with output that is input to a BN layer followed by a LeakyReLU activation that produces an output data set of dimension 512×64, and 512×W convolution operation with kernel size 3 that outputs a BN data set of dimension W×64. Output from the one or more ResNet operations may be a W×64 matrix.

The encoding device may perform a W×V convolution operation on output from the one or more ResNet operations. The W×V convolution operation may include a pointwise (e.g., tap-wise) convolution operation. The W×V convolution operation may compress spatial features into a reduced dimension for each tap. The W×V convolution operation has an input of W features and an output of V features. Output from the W×V convolution operation may be a V×64 matrix.

The encoding device may perform a flattening operation to flatten the V×64 matrix into a 64V element vector. The encoding device may perform a 64 V×M fully connected operation to further compress the spatial-temporal feature data set into a low dimension vector of size M for transmission over the air to the decoding device. The encoding device may perform quantization before the over the air transmission of the low dimension vector of size M to map sampling of the transmission into discrete values for the low dimension vector of size M.

The decoding device may perform an M×64 V fully connected operation to decompress the low dimension vector of size M into a spatial-temporal feature data set. The decoding device may perform a reshaping operation to reshape the 64V element vector into a 2-dimensional V×64 matrix. The decoding device may perform a V×W (with kernel of 1) convolution operation on output from the reshaping operation. The V×W convolution operation may include a pointwise (e.g., tap-wise) convolution operation. The V×W convolution operation may decompress spatial features from a reduced dimension for each tap. The V×W convolution operation has an input of V features and an output of W features. Output from the V×W convolution operation may be a W×64 matrix.

The decoding device may perform one or more ResNet operations. The one or more ResNet operations may further decompress the spatial feature and/or the temporal feature. A ResNet operation may include multiple (e.g., 3) 1-dimensional convolution operations, a skip connection (e.g., to avoid application of the 1-dimensional convolution operations), a summation operation of a path through the multiple convolution operations and a path through the skip connection, and/or the like. Output from the one or more ResNet operations may be a W×64 matrix.

The decoding device may perform a spatial and temporal feature reconstruction. This may be accomplished through the use of a 1-dimensional convolutional operation that is fully connected in the spatial dimension (to reconstruct the spatial feature) and simple convolution with a small kernel size (e.g., 3) in the tap dimension (to reconstruct the short tap feature). Output from the 64×W convolution operation may be a 64×64 matrix.

Values of M, W, and/or V may be configurable to adjust weights of the features, payload size, and/or the like.

As indicated above, FIG. 6 is provided merely as an example. Other examples may differ from what is described with regard to FIG. 6.

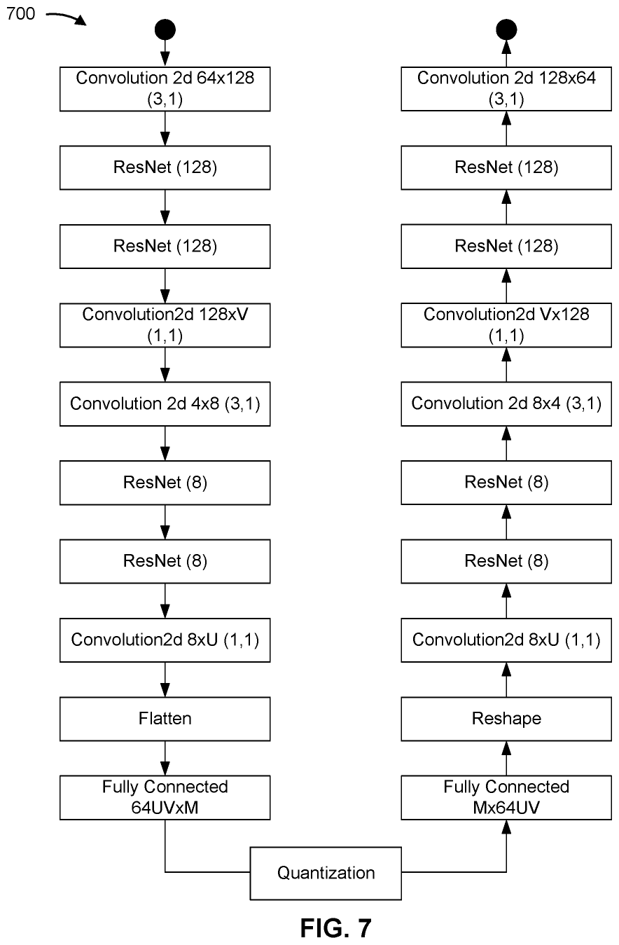

FIG. 7 is a diagram illustrating an example 700 associated with encoding and decoding a data set using a neural network for uplink communication, in accordance with the present disclosure. An encoding device (e.g., UE 120, encoding device 300, and/or the like) may be configured to perform one or more operations on samples (e.g., data) received via one or more antennas of the encoding device to compress the samples. A decoding device (e.g., base station 110, decoding device 350, and/or the like) may be configured to decode the compressed samples to determine information, such as CSF. As shown by example 700, features may be compressed and decompressed in sequence. For example, the encoding device may extract and compress features associated with the input to produce a payload, and then the decoding device may extract and compress features associated with the payload to reconstruct the input. The encoding and decoding operations may be symmetric (as shown) or asymmetric.

As shown by example 700, the encoding device may receive sampling from antennas. For example, the encoding device may receive a 256×64 dimension data set based at least in part on a number of antennas, a number of samples per antenna, and a tap feature. The encoding device may reshape the data to a (64×64×4) data set.

The encoding device may perform a 2-dimensional 64×128 convolution operation (with kernel sizes of 3 and 1). In some aspects, the 64×128 convolution operation may perform a spatial feature extraction associated with the decoding device antenna dimension, a short temporal (tap) feature extraction associated with the decoding device (e.g., base station) antenna dimension, and/or the like. This may be accomplished through the use of a 2D convolutional layer that is fully connected in a decoding device antenna dimension, a simple convolutional operation with a small kernel size (e.g., 3) in the tap dimension and a small kernel size (e.g., 1) in the encoding device antenna dimension. Output from the 64×W convolution operation may be a (128×64×4) dimension matrix.

The encoding device may perform one or more ResNet operations. The one or more ResNet operations may further refine the spatial feature associated with the decoding device and/or the temporal feature associated with the decoding device. In some aspects, a ResNet operation may include multiple operations associated with a feature. For example, a ResNet operation may include multiple (e.g., 3) 2-dimensional convolution operations, a skip connection (e.g., between input of the ResNet and output of the ResNet to avoid application of the 2-dimensional convolution operations), a summation operation of a path through the multiple 2-dimensional convolution operations and a path through the skip connection, and/or the like. The multiple 2-dimensional convolution operations may include a W×2W convolution operation with kernel sizes 3 and 1 with output that is input to a BN layer followed by a LeakyReLU activation that produces an output data set of dimension 2W×64×V, a 2W×4W convolution operation with kernel sizes 3 and 1 with output that is input to a BN layer followed by a LeakyReLU activation that produces an output data set of dimension 4W×64×V, and 4W×W convolution operation with kernel sizes 3 and 1 that outputs a BN data set of dimension (128×64×4). Output from the one or more ResNet operations may be a (128×64×4) dimension matrix.

The encoding device may perform a 2-dimensional 128×V convolution operation (with kernel sizes of 1 and 1) on output from the one or more ResNet operations. The 128×V convolution operation may include a pointwise (e.g., tap-wise) convolution operation. The W×V convolution operation may compress spatial features associated with the decoding device into a reduced dimension for each tap. Output from the 128×V convolution operation may be a (4×64×V) dimension matrix.

The encoding device may perform a 2-dimensional 4×8 convolution operation (with kernel sizes of 3 and 1). The 4×8 convolution operation may perform a spatial feature extraction associated with the encoding device antenna dimension, a short temporal (tap) feature extraction associated with the encoding device antenna dimension, and/or the like. Output from the 4×8 convolution operation may be a (8×64×V) dimension matrix.

The encoding device may perform one or more ResNet operations. The one or more ResNet operations may further refine the spatial feature associated with the encoding device and/or the temporal feature associated with the encoding device. A ResNet operation may include multiple operations associated with a feature. For example, a ResNet operation may include multiple (e.g., 3) 2-dimensional convolution operations, a skip connection (e.g., to avoid application of the 2-dimensional convolution operations), a summation operation of a path through the multiple 2-dimensional convolution operations and a path through the skip connection, and/or the like. Output from the one or more ResNet operations may be a (8×64×V) dimension matrix.

The encoding device may perform a 2-dimensional 8×U convolution operation (with kernel sizes of 1 and 1) on output from the one or more ResNet operations. The 8×U convolution operation may include a pointwise (e.g., tap-wise) convolution operation. The 8×U convolution operation may compress spatial features associated with the decoding device into a reduced dimension for each tap. Output from the 128×V convolution operation may be a (U×64×V) dimension matrix.

The encoding device may perform a flattening operation to flatten the (U×64×V) dimension matrix into a 64 UV element vector. The encoding device may perform a 64UV×M fully connected operation to further compress a 2-dimensional spatial-temporal feature data set into a low dimension vector of size M for transmission over the air to the decoding device. The encoding device may perform quantization before the over the air transmission of the low dimension vector of size M to map sampling of the transmission into discrete values for the low dimension vector of size M.

The decoding device may perform an M×64 UV fully connected operation to decompress the low dimension vector of size M into a spatial-temporal feature data set. The decoding device may perform a reshaping operation to reshape the 64 UV element vector into a (U×64×V) dimensional matrix. The decoding device may perform a 2-dimensional U×8 (with kernel of 1, 1) convolution operation on output from the reshaping operation. The U×8 convolution operation may include a pointwise (e.g., tap-wise) convolution operation. The U×8 convolution operation may decompress spatial features from a reduced dimension for each tap. Output from the U×8 convolution operation may be a (8×64×V) dimension data set.

The decoding device may perform one or more ResNet operations. The one or more ResNet operations may further decompress the spatial feature and/or the temporal feature associated with the encoding device. In some aspects, a ResNet operation may include multiple (e.g., 3) 2-dimensional convolution operations, a skip connection (e.g., to avoid application of the 2-dimensional convolution operations), a summation operation of a path through the multiple 2-dimensional convolution operations and a path through the skip connection, and/or the like. Output from the one or more ResNet operations may be a (8×64×V) dimension data set.

The decoding device may perform a 2-dimensional 8×4 convolution operation (with kernel sizes of 3 and 1). The 8×4 convolution operation may perform a spatial feature reconstruction in the encoding device antenna dimension, and a short temporal feature reconstruction, and/or the like. Output from the 8×4 convolution operation may be a (V×64×4) dimension data set.

The decoding device may perform a 2-dimensional V×128 (with kernel of 1) convolution operation on output from the 2-dimensional 8×4 convolution operation to reconstruct a tap feature and a spatial feature associated with the decoding device. The V×128 convolution operation may include a pointwise (e.g., tap-wise) convolution operation. The V×128 convolution operation may decompress spatial features associated with the decoding device antennas from a reduced dimension for each tap. Output from the U×8 convolution operation may be a (128×64×4) dimension matrix.

The decoding device may perform one or more ResNet operations. The one or more ResNet operations may further decompress the spatial feature and/or the temporal feature associated with the decoding device. A ResNet operation may include multiple (e.g., 3) 2-dimensional convolution operations, a skip connection (e.g., to avoid application of the 2-dimensional convolution operations), a summation operation of a path through the multiple 2-dimensional convolution operations and a path through the skip connection, and/or the like. Output from the one or more ResNet operations may be a (128×64×4) dimension matrix.

The decoding device may perform a 2-dimensional 128×64 convolution operation (with kernel sizes of 3 and 1). In some aspects, the 128×64 convolution operation may perform a spatial feature reconstruction associated with the decoding device antenna dimension, a short temporal feature reconstruction, and/or the like. Output from the 128×64 convolution operation may be a (64×64×4) dimension data set.

In some aspects, values of M, V, and/or U may be configurable to adjust weights of the features, payload size, and/or the like. For example, a value of/A/may be 32, 64, 128, 256, or 512, a value of V may be 16, and/or a value of U may be 1.

As indicated above, FIG. 7 is provided merely as an example. Other examples may differ from what is described with regard to FIG. 7.

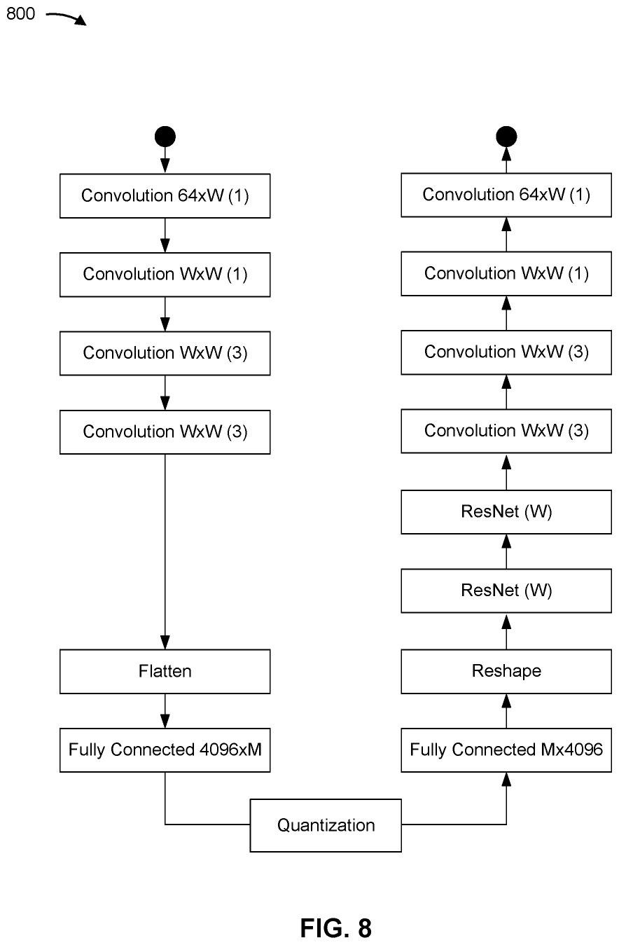

FIG. 8 is a diagram illustrating an example 800 associated with encoding and decoding a data set using a neural network for uplink communication, in accordance with the present disclosure. An encoding device (e.g., UE 120, encoding device 300, and/or the like) may be configured to perform one or more operations on samples (e.g., data) received via one or more antennas of the encoding device to compress the samples. A decoding device (e.g., base station 110, decoding device 350, and/or the like) may be configured to decode the compressed samples to determine information, such as CSF. The encoding device and decoding device operations may be asymmetric. In other words, the decoding device may have a greater number of layers than the decoding device.

As shown by example 800, the encoding device may receive sampling from antennas. For example, the encoding device may receive a 64×64 dimension data set based at least in part on a number of antennas, a number of samples per antenna, and a tap feature.

The encoding device may perform a 64×W convolution operation (with a kernel size of 1). In some aspects, the 64×W convolution operation may be fully connected in antennas, convolution in taps, and/or the like. Output from the 64×W convolution operation may be a W×64 matrix. The encoding device may perform one or more W×W convolution operations (with a kernel size of 1 or 3). Output from the one or more W×W convolution operations may be a W×64 matrix. The encoding device may perform the convolution operations (with a kernel size of 1). The one or more W×W convolution operations may perform a spatial feature extraction, a short temporal (tap) feature extraction, and/or the like. The W×W convolution operations may be a series of 1-dimensional convolution operations.

The encoding device may perform a flattening operation to flatten the W×64 matrix into a 64W element vector. The encoding device may perform a 4096×M fully connected operation to further compress the spatial-temporal feature data set into a low dimension vector of size M for transmission over the air to the decoding device. The encoding device may perform quantization before the over the air transmission of the low dimension vector of size M to map sampling of the transmission into discrete values for the low dimension vector of size M.

The decoding device may perform a 4096×M fully connected operation to decompress the low dimension vector of size M into a spatial-temporal feature data set. The decoding device may perform a reshaping operation to reshape the 6W element vector into a W×64 matrix.

The decoding device may perform one or more ResNet operations. The one or more ResNet operations may decompress the spatial feature and/or the temporal feature. In some aspects, a ResNet operation may include multiple (e.g., 3) 1-dimensional convolution operations, a skip connection (e.g., between input of the ResNet and output of the ResNet to avoid application of the 1-dimensional convolution operations), a summation operation of a path through the multiple 1-dimensional convolution operations and a path through the skip connection, and/or the like. The multiple 1-dimensional convolution operations may include a W×256 convolution operation with kernel size 3 with output that is input to a BN layer followed by a LeakyReLU activation that produces an output data set of dimension 256×64, a 256×512 convolution operation with kernel size 3 with output that is input to a BN layer followed by a LeakyReLU activation that produces an output data set of dimension 512×64, and 512×W convolution operation with kernel size 3 that outputs a BN data set of dimension W×64. Output from the one or more ResNet operations may be a W×64 matrix.

The decoding device may perform one or more W×W convolution operations (with a kernel size of 1 or 3). Output from the one or more W×W convolution operations may be a W×64 matrix. The encoding device may perform the convolution operations (with a kernel size of 1). The W×W convolution operations may perform a spatial feature reconstruction, a short temporal (tap) feature reconstruction, and/or the like. The W×W convolution operations may be a series of 1-dimensional convolution operations.

The encoding device may perform a W×64 convolution operation (with a kernel size of 1). The W×64 convolution operation may be a 1-dimensional convolution operation. Output from the 64×W convolution operation may be a 64×64 matrix.

In some aspects, values of M, and/or W may be configurable to adjust weights of the features, payload size, and/or the like.

As indicated above, FIG. 8 is provided merely as an example. Other examples may differ from what is described with regard to FIG. 8.

As described above, a UE (an encoding device) may have limited resources for use in processing channel state information to generate a channel state feedback report. For example, a UE may have less than a threshold battery level. As another example, a UE may have less than a threshold available processing resources, such as when processing resources are assigned to other tasks. The UE may be configured with a plurality of different processing types for processing the channel state information. For example, the UE may have a plurality of different neural network models for processing the channel state information to reduce overhead during transmission of a channel state feedback report. As another example, the UE may have non-neural network-based techniques for processing channel state information to generate a channel state feedback report.

Some aspects described herein enable the UE to transition between different processing types for channel state feedback processing. For example, based at least in part on determining that a power threshold is satisfied, such as a threshold related to a battery level, a threshold related to an availability of processing resources, among other examples, the UE may transition from a first processing type to a second processing type. In such cases, for example, the UE may detect less than a threshold battery level and may transition from using a first neural network processing technique that uses a relatively high level of processing resources and associated battery resources to a second neural network processing technique that uses a relatively low level of processing resources.

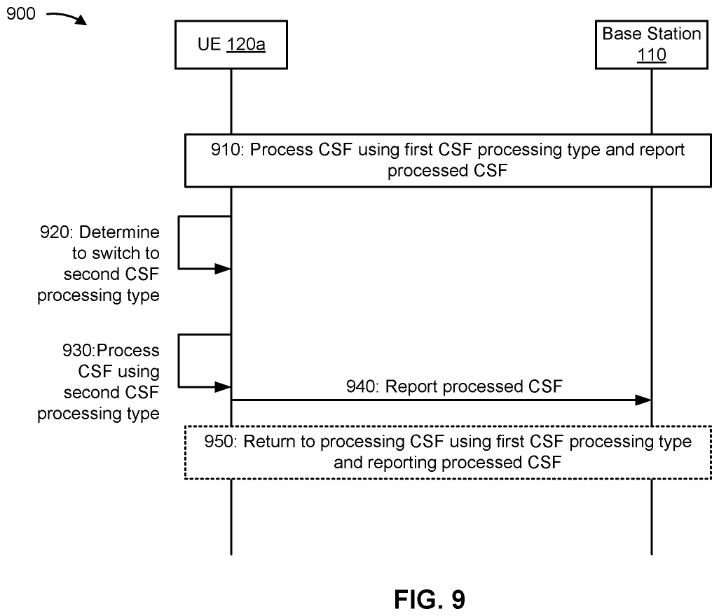

FIG. 9 is a diagram illustrating an example 900 associated with power control for channel state feedback processing, in accordance with the present disclosure. As shown in FIG. 9, example 900 includes communication between a base station 110 (which may include a decoding device and may correspond to a second device described herein) and a UE 120a (which may include an encoding device and may correspond to a first device described herein). In some aspects, base station 110 and UE 120a may be included in a wireless network, such as wireless network 100. Base station 110 and UE 120a may communicate on a wireless access link, which may include an uplink and a downlink.

As further shown in FIG. 9, and by reference number 910, UE 120a may process channel state feedback using a first channel state feedback processing type and may report the processed channel state feedback. For example, UE 120a may process channel state information using a first neural network architecture, as described above, and may report the processed channel state information. In some aspects, UE 120a may receive configuration information associated with configuring channel state feedback processing types. For example, UE 120a may receive signaling, such as radio resource control (RRC) signaling, medium access control (MAC) control element (CE) signaling, downlink control information (DCI) signaling, among other examples, identifying the first channel state feedback processing type. Additionally, or alternatively, UE 120a may receive signaling identifying a second channel state feedback processing type to which UE 120a is to switch to using when a switching condition is satisfied. Additionally, or alternatively, UE 120a may receive information configuring a switching condition for triggering a switch between channel state feedback processing types. For example, UE 120a may receive, from base station 110, signaling identifying a threshold power level at which to switch from a relatively power-intensive channel state feedback processing type to a less power-intensive channel state feedback processing type. Additionally, or alternatively, UE 120a may autonomously set the threshold power level, such as based at least in part on a specified, static threshold power level, based at least in part on tracking data relating to previous channel state feedback processing and power levels, among other examples.

As further shown in FIG. 9, and by reference number 920, UE 120a may determine to switch to a second channel state feedback processing type. For example, UE 120a may determine that a threshold power level, configured by base station 110 or autonomously by UE 120a as described above, is satisfied and may switch to a less power intensive channel state feedback processing type. As described above, a less power intensive channel state feedback processing type may be, for example, a second neural network architecture with, for example, fewer layers. In one or more examples, channel state feedback processing using the second neural network architecture may result in lower spectral efficiency than using the first neural network architecture, but may also use less processing resources and, accordingly, less power resources.

Additionally, or alternatively, UE 120a may switch from a neural network-based channel state feedback processing type to a non-neural network-based channel state feedback processing type. For example, UE 120a may switch from transmitting type-III channel state information to transmitting type-I or type-II channel state information, which may each be associated with reduced power consumption relative to generating type-III channel state information. Type-I channel state information may be a beam selection scheme wherein an encoding device (UE 120a) selects best beam indices and sends channel state information as channel state feedback to a decoding device (e.g., base station 110). Type-II channel state information may be a beam-combination scheme, where the encoding device also computes a best linear combination of coefficients of various beams and sends back the beam indices and the coefficients used for combining them, on a sub-band (e.g., configured sub-band) basis. Type-III CSI is a neural-network-based processing and reporting technique as described above.

As further shown in FIG. 9, and by reference numbers 930 and 940, UE 120a may process channel state feedback using the second channel state feedback processing type and may report the channel state feedback. For example, UE 120a may process channel state information using the second neural network architecture, a non-neural-network-based processing type, among other examples to generate channel state feedback for reporting. In some aspects, UE 120a may provide an indicator of the second channel state feedback processing type. For example, in connection with transmitting channel state feedback, such as in the same message or a message transmitted using time or frequency resources within a threshold proximity of the channel state feedback, UE 120a may provide an identifier of the second channel state feedback processing type. In such examples, UE 120a may transmit a PUCCH, a PUSCH, among other examples to convey the identifier of the second channel state feedback type.

As a result, base station 110 may use the identifier to determine which decoding algorithm to use to decode the channel state feedback. Additionally, or alternatively, base station 110 may blind decode the channel state feedback based at least in part on attempting to decode the channel state feedback using one or more different algorithms and using a checksum to confirm decoding success. Additionally, or alternatively, UE 120a may transmit an identifier indicating that UE 120a has switched channel state feedback processing types without explicitly identifying the second channel state feedback processing type. In such examples, based at least in part on base station 110 signaling the second channel state feedback processing type to UE 120a, base station 110 may decode the channel state feedback without receiving an explicit identifier of the second channel state feedback processing type from UE 120a.

As further shown in FIG. 9, and by reference number 950, after a period of time, UE 120a may return to using the first channel state feedback processing type. For example, UE 120a may return to using the first channel state feedback processing type based at least in part on detecting that an external power source is connected to UE 120a. Additionally, or alternatively, UE 120a may return to using the first channel state feedback processing type based at least in part on detecting that a current power level exceeds a threshold power level. In such examples, UE 120a may switch back to the first channel state feedback processing type based at least in part on a condition configured by base station 110 or based at least in part on an autonomous determination. In some aspects, UE 120a may transmit signaling indicating the switch back to the first channel state feedback processing type or explicitly identifying the first channel state feedback processing type, such as using a PUCCH, a PUSCH, among other examples. Additionally, or alternatively, UE 120a may further switch to a third channel state feedback processing type, a fourth channel state feedback processing type, among other examples, such as based at least in part on satisfaction of another switching criterion (a lower threshold power level).

As indicated above, FIG. 9 is provided as an example. Other examples may differ from what is described with respect to FIG. 9.

FIG. 10 is a diagram illustrating an example process 1000 performed, for example, by a first device, in accordance with the present disclosure. Example process 1000 is an example where the first device (e.g., an encoding device, UE 120, among other examples) performs operations associated with power control for channel state feedback processing.

As shown in FIG. 10, in some aspects, process 1000 may include generating first channel state feedback using a first type of channel state feedback processing (block 1010). For example, the first device (e.g., using generation component 1112) may generate first channel state feedback using a first type of channel state feedback processing, as described above.

As shown in FIG. 10, in some aspects, process 1000 may include transmitting the first channel state feedback (block 1020). For example, the first device (e.g., using transmission component 1104) may transmit the first channel state feedback, as described above.

As shown in FIG. 10, in some aspects, process 1000 may include determining that a power threshold for the first device is satisfied (block 1030). For example, the first device (e.g., using determination component 1108) may determine that a power threshold for the first device is satisfied, as described above.

As further shown in FIG. 10, in some aspects, process 1000 may include transitioning from the first type of channel state feedback processing to a second type of channel state feedback processing based at least in part on determining that the power threshold for the first device is satisfied (block 1040). For example, the first device (e.g., using transition component 1110) may transition from the first type of channel state feedback processing to a second type of channel state feedback processing based at least in part on determining that the power threshold for the first device is satisfied, as described above.

As shown in FIG. 10, in some aspects, process 1000 may include generating second channel state feedback using the second type of channel state feedback processing (block 1050). For example, the first device (e.g., using generation component 1112) may generate second channel state feedback using the second type of channel state feedback processing, as described above.

As shown in FIG. 10, in some aspects, process 1000 may include transmitting the second channel state feedback (block 1060). For example, the first device (e.g., using transmission component 1104) may transmit the second channel state feedback, as described above.

As shown in FIG. 10, in some aspects, process 1000 may include transmitting information identifying the second type of channel state feedback (block 1062). For example, the first device (e.g., using transmission component 1104) may transmit information identifying the second type of channel state feedback, as described above.

As further shown in FIG. 10, in some aspects, process 1000 may include transitioning back to the first type of channel state feedback processing (block 1070). For example, the first device (e.g., using transition component 1110) may transition from the second type of channel state feedback processing to the first type of channel state feedback processing based at least in part on determining that the power threshold for the first device is satisfied, as described above.

Process 1000 may include additional aspects, such as any single aspect or any combination of aspects described below and/or in connection with one or more other processes described elsewhere herein.

In a first aspect, process 1000 includes transmitting, before determining that the power threshold for the first device is satisfied, first channel state feedback processed using the first type of channel state feedback processing, and transmitting, after transitioning from the first type of channel state feedback processing to the second type of channel state feedback processing, second channel state feedback processed using the second type of channel state feedback processing.

In a second aspect, alone or in combination with the first aspect, process 1000 includes determining channel state information, for reporting, using the second type of channel state feedback processing based at least in part on transitioning from the first type of channel state feedback processing to the second type of channel state feedback processing.

In a third aspect, alone or in combination with one or more of the first and second aspects, at least one of the first type of channel state feedback processing or the second type of channel state feedback processing includes generating Type-I channel state information, Type-II channel state information, Type-III channel state information, or a combination thereof.

In a fourth aspect, alone or in combination with one or more of the first through third aspects, the first type of channel state feedback processing is a first type of neural network processing with a first architecture.

In a fifth aspect, alone or in combination with one or more of the first through fourth aspects, the second type of channel state feedback processing is a second type of neural network processing with a second architecture.

In a sixth aspect, alone or in combination with one or more of the first through fifth aspects, the second type of channel state feedback processing is a non-neural network type of processing.

In a seventh aspect, alone or in combination with one or more of the first through sixth aspects, process 1000 includes receiving signaling identifying a configuration for channel state feedback processing switching, and wherein transitioning from the first type of channel state feedback processing to the second type of channel state feedback processing comprises transitioning from the first type of channel state feedback processing to the second type of channel state feedback processing based at least in part on the configuration for channel state feedback processing switching.

In an eighth aspect, alone or in combination with one or more of the first through seventh aspects, the signaling includes radio resource control signaling, downlinking control information signaling, MAC-CE signaling, or a combination thereof.

In a ninth aspect, alone or in combination with one or more of the first through eighth aspects, the configuration for channel state feedback processing switching includes information identifying the power threshold, the first type of channel state feedback processing, the second type of channel state feedback processing, or a combination thereof.

In a tenth aspect, alone or in combination with one or more of the first through ninth aspects, the power threshold is a first device-defined threshold.

In an eleventh aspect, alone or in combination with one or more of the first through tenth aspects, process 1000 includes transmitting information identifying the second type of channel state feedback processing based at least in part on transitioning from the first type of channel state feedback processing to the second type of channel state feedback processing.

In a twelfth aspect, alone or in combination with one or more of the first through eleventh aspects, the information identifying the second type of channel state feedback processing is included in a physical uplink control channel or a physical uplink shared channel.

In a thirteenth aspect, alone or in combination with one or more of the first through twelfth aspects, process 1000 includes transitioning, after transitioning to the second type of channel state feedback processing, from the second type of channel state feedback processing to the first type of channel state feedback processing.

In a fourteenth aspect, alone or in combination with one or more of the first through thirteenth aspects, the transitioning to the first type of channel state feedback processing is based at least in part on expiration of a threshold period of time, satisfaction of the power threshold, satisfaction of another power threshold, a connection of the first device to a power source, or a combination thereof.

In a fifteenth aspect, alone or in combination with one or more of the first through fourteenth aspects, the transitioning to the first type of channel state feedback processing is based at least in part on receiving signaling configuring the transition to the first type of channel state feedback processing, a first device determination of a satisfaction of a switching criterion, or a combination thereof.

In a sixteenth aspect, alone or in combination with one or more of the first through fifteenth aspects, process 1000 includes transmitting information identifying the first type of channel state feedback processing based at least in part on transitioning to the first type of channel state feedback processing.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

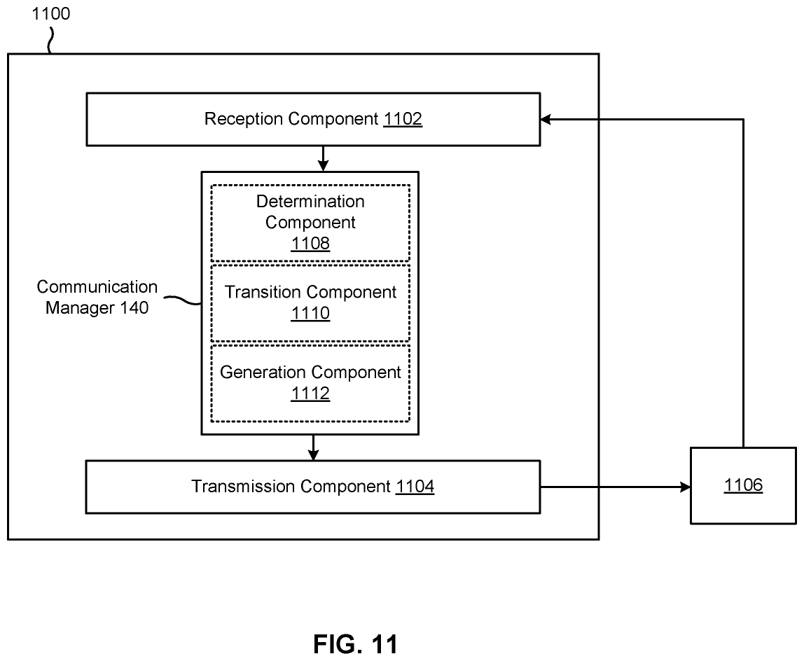

FIG. 11 is a block diagram of an example apparatus 1100 for wireless communication. The apparatus 1100 may be a first device (an encoding device, a UE, such as UE 120a), or a first device may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a second device, which may be a UE, a base station, or another wireless communication device) using the reception component 1102 and the transmission component 1104. As further shown, the apparatus 1100 may include a communication manager 140, that includes one or more of a determination component 1108, a transition component 1110, or a generation component 1112, among other examples.

In some aspects, the apparatus 1100 may be configured to perform one or more operations described herein in connection with FIG. 9. Additionally, or alternatively, the apparatus 1100 may be configured to perform one or more processes described herein, such as process 1000 of FIG. 10 among other examples. In some aspects, the apparatus 1100 and/or one or more components shown in FIG. 11 may include one or more components of the UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. In some aspects, the reception component 1102 may receive signaling identifying a configuration for channel state feedback processing switching. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, the transmission component 1104 may transmit first channel state feedback processing using a first channel state feedback processing type, second channel state feedback processed using a second channel state feedback processing type, among other examples. In some aspects, the transmission component 1104 may transmit information identifying a type of channel state feedback processing used to process channel state feedback. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described above in connection with FIG. 2. In some aspects, the transmission component 1104 may be collocated with the reception component 1102 in a transceiver.

The determination component 1108 may determine that a power threshold for the UE is satisfied. In some aspects, the determination component 1108 may determine channel information using a particular channel state feedback processing type. In some aspects, the determination component 1108 may determine a satisfaction of a switching criterion or condition. In some aspects, the determination component 1108 may include a receive processor, a transmit processor, a controller/processor, a memory, or a combination thereof, of the UE described above in connection with FIG. 2.

The transition component 1110 may transition from a first type of channel state feedback processing to a second type of channel state feedback processing based at least in part on determining that the power threshold for the UE is satisfied. In some aspects, the transition component 1110 may include one or more antennas, a demodulator, a MIMO detector, a receive processor, a modulator, a transmit MIMO processor, a transmit processor, a controller/processor, a memory, or a combination thereof, of the UE described above in connection with FIG. 2. In some aspects, the transition component 1110 may transition, after transitioning to the second type of channel state feedback processing, from the second type of channel state feedback processing to the first type of channel state feedback processing.

The generation component 1112 may generate channel state information, such as Type-I channel state information, Type-II channel state information, Type-III channel state information, among other examples. For example, the generation component 1112 may generate channel state information using a neural network or another non-neural network technique. In some aspects, the generation component 1112 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

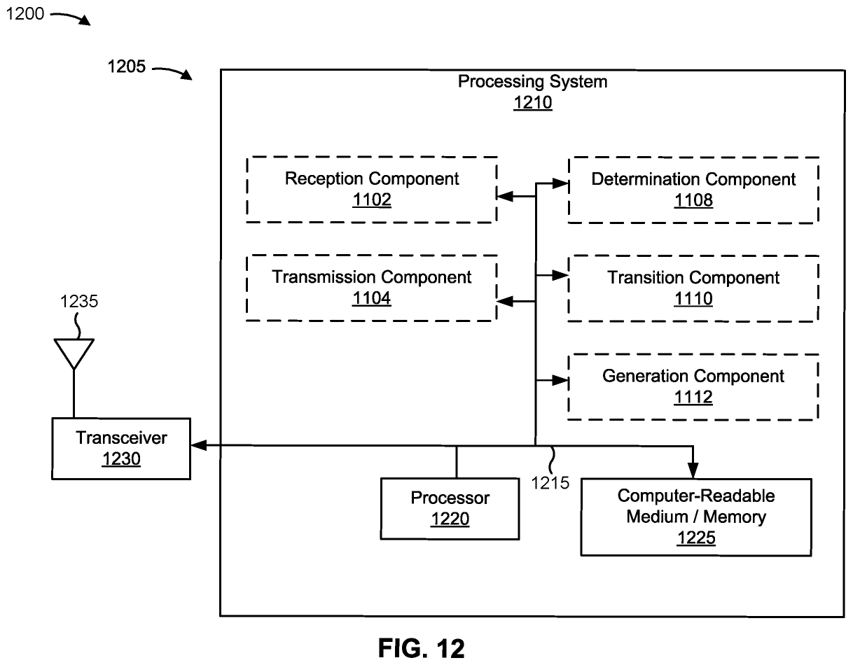

FIG. 12 is a diagram illustrating an example 1200 of a hardware implementation for an apparatus 1205 employing a processing system 1210. The apparatus 1205 may be a UE, such as UE 120a.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor 1220, the illustrated components, and the computer-readable medium/memory 1225. The bus 1215 may also link various other circuits, such as timing sources, peripherals, voltage regulators, power management circuits, and/or the like.

The processing system 1210 may be coupled to a transceiver 1230. The transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes a processor 1220 coupled to a computer-readable medium/memory 1225. The processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software. The processing system further includes at least one of the illustrated components. The components may be software modules running in the processor 1220, resident/stored in the computer-readable medium/memory 1225, one or more hardware modules coupled to the processor 1220, or some combination thereof.

In some aspects, the processing system 1210 may be a component of a UE 120 (UE 120a) and may include the memory 282 and/or at least one of the TX MIMO processor 266, the receive (RX) processor 258, and/or the controller/processor 280. In some aspects, the apparatus 1205 for wireless communication includes means for determining that a power threshold for the UE is satisfied, means for transitioning from a first type of channel state feedback processing to a second type of channel state feedback processing based at least in part on determining that the power threshold for the UE is satisfied, means for transmitting, before determining that the power threshold for the UE is satisfied, first channel state feedback processed using the first type of channel state feedback processing, among other examples.

Additionally, or alternatively, the apparatus 1205 may include means for transmitting, after transitioning from the first type of channel state feedback processing to the second type of channel state feedback processing, second channel state feedback processed using the second type of channel state feedback processing, means for determining channel state information, for reporting, using the second type of channel state feedback processing based at least in part on transitioning from the first type of channel state feedback processing to the second type of channel state feedback processing, among other examples. Additionally, or alternatively, the apparatus 1205 may include means for receiving signaling identifying a configuration for channel state feedback processing switching, means for transitioning from the first type of channel state feedback processing to the second type of channel state feedback processing based at least in part on the configuration for channel state feedback processing switching, among other examples.

Additionally, or alternatively, the apparatus 1205 may include means for transmitting information identifying the second type of channel state feedback processing based at least in part on transitioning from the first type of channel state feedback processing to the second type of channel state feedback processing, means for transitioning, after transitioning to the second type of channel state feedback processing, from the second type of channel state feedback processing to the first type of channel state feedback processing, means for transmitting information identifying the first type of channel state feedback processing based at least in part on transitioning to the first type of channel state feedback processing.

The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 12 is provided as an example. Other examples may differ from what is described in connection with FIG. 12.

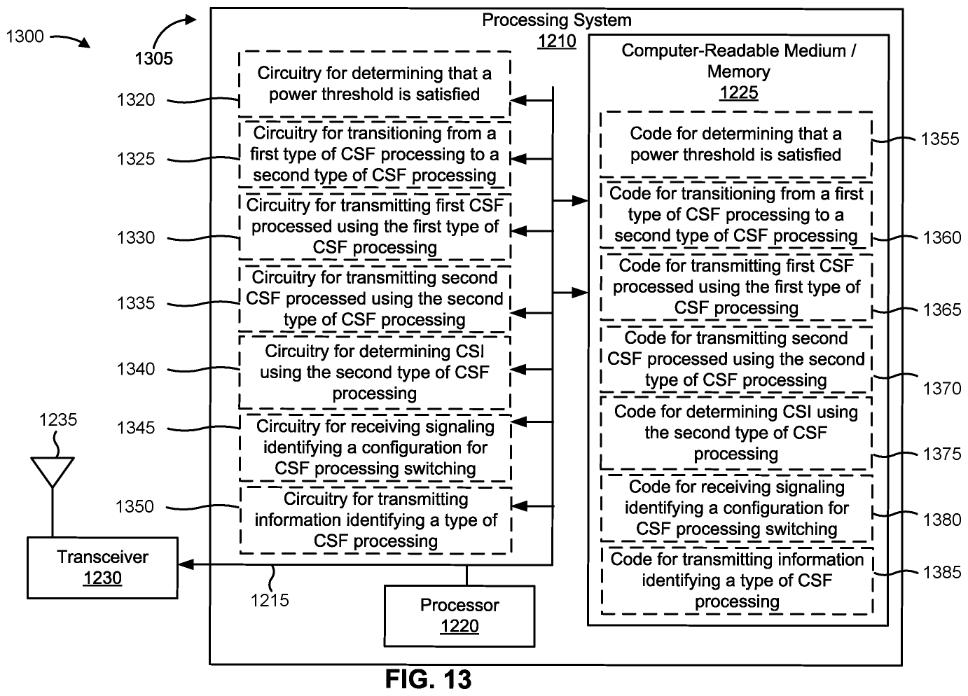

FIG. 13 is a diagram illustrating an example 1300 of an implementation of code and circuitry for an apparatus 1305. The apparatus 1305 may be a UE, such as UE 120a among other examples.

As further shown in FIG. 13, the apparatus may include circuitry for determining that a power threshold is satisfied (circuitry 1320). For example, the apparatus may include circuitry to enable the apparatus to determine that a power threshold is satisfied.

As further shown in FIG. 13, the apparatus may include circuitry for transitioning from a first type of channel state feedback processing to a second type of channel state feedback processing (circuitry 1325). For example, the apparatus may include circuitry to enable the apparatus to transition from a first type of channel state feedback processing to a second type of channel state feedback processing.

As further shown in FIG. 13, the apparatus may include circuitry for transmitting first channel state feedback processed using the first type of channel state feedback processing (circuitry 1330). For example, the apparatus may include circuitry to enable the apparatus to transmit first channel state feedback processed using the first type of channel state feedback processing.

As further shown in FIG. 13, the apparatus may include circuitry for transmitting second channel state feedback processed using the second type of channel state feedback processing (circuitry 1335). For example, the apparatus may include circuitry to enable the apparatus to transmit second channel state feedback processed using the second type of channel state feedback processing.

As further shown in FIG. 13, the apparatus may include circuitry for determining channel state information using the second type of channel state feedback processing (circuitry 1340). For example, the apparatus may include circuitry to enable the apparatus to determine channel state information using the second type of channel state feedback processing.

As further shown in FIG. 13, the apparatus may include circuitry for receiving signaling identifying a configuration for channel state feedback processing switching (circuitry 1345). For example, the apparatus may include circuitry to enable the apparatus to receive signaling identifying a configuration for channel state feedback processing switching.

As further shown in FIG. 13, the apparatus may include circuitry for transmitting information identifying a type of channel state feedback processing (circuitry 1350). For example, the apparatus may include circuitry to enable the apparatus to transmit information indicating that the first type or the second type of channel state feedback processing is being used.

As further shown in FIG. 13, the apparatus may include, stored in computer-readable medium 1225, code for determining that a power threshold is satisfied (code 1355). For example, the apparatus may include code that, when executed by the processor 1220, may cause the processor 1220 to determine that a power threshold is satisfied.

As further shown in FIG. 13, the apparatus may include, stored in computer-readable medium 1225, code for transitioning from a first type of channel state feedback processing to a second type of channel state feedback processing (code 1360). For example, the apparatus may include code that, when executed by the processor 1220, may cause the processor 1220 to transition from a first type of channel state feedback processing to a second type of channel state feedback processing.

As further shown in FIG. 13, the apparatus may include, stored in computer-readable medium 1225, code for transmitting first channel state feedback processed using the first type of channel state feedback processing (code 1365). For example, the apparatus may include code that, when executed by the processor 1220, may cause the transceiver 1230 to transmit first channel state feedback processed using the first type of channel state feedback processing.

As further shown in FIG. 13, the apparatus may include, stored in computer-readable medium 1225, code for transmitting second channel state feedback processed using the second type of channel state feedback processing (code 1370). For example, the apparatus may include code that, when executed by the processor 1220, may cause the transceiver 1230 to transmit second channel state feedback processed using the second type of channel state feedback processing.

As further shown in FIG. 13, the apparatus may include, stored in computer-readable medium 1225, code for determining channel state information using the second type of channel state feedback processing (code 1375). For example, the apparatus may include code that, when executed by the processor 1220, may cause the processor 1220 to determine channel state information using the second type of channel state feedback processing.

As further shown in FIG. 13, the apparatus may include, stored in computer-readable medium 1225, code for receiving signaling identifying a configuration for channel state feedback processing switching (code 1380). For example, the apparatus may include code that, when executed by the processor 1220, may cause the transceiver 1230 to receive signaling identifying a configuration for channel state feedback processing switching.

As further shown in FIG. 13, the apparatus may include, stored in computer-readable medium 1225, code for transmitting information identifying a type of channel state feedback processing (code 1385). For example, the apparatus may include code that, when executed by the processor 1220, may cause the transceiver 1230 to transmit information identifying the first type or the second type of channel state feedback processing.

FIG. 13 is provided as an example. Other examples may differ from what is described in connection with FIG. 13.

FIG. 14 is a diagram illustrating an example process 1400 performed, for example, by a UE, in accordance with the present disclosure. Example process 1400 is an example where the first device (e.g., an encoding device, UE 120, apparatus 1100 of FIG. 11, and/or the like) performs operations associated with encoding a data set using a neural network.

As shown in FIG. 14, in some aspects, process 1400 may include encoding a data set using one or more extraction operations and compression operations associated with a neural network, the one or more extraction operations and compression operations being based at least in part on a set of features of the data set to produce a compressed data set (block 1410). For example, the first device (e.g., using determination component 1108, an encoding component, among other examples) may encode a data set using one or more extraction operations and compression operations associated with a neural network, the one or more extraction operations and compression operations being based at least in part on a set of features of the data set to produce a compressed data set, as described above.

As further shown in FIG. 14, in some aspects, process 1400 may include transmitting the compressed data set to a base station (block 1420). For example, the UE (e.g., using transmission component 1104) may transmit the compressed data set to a base station, as described above.

Process 1400 may include additional aspects, such as any single aspect or any combination of aspects described below and/or in connection with one or more other processes described elsewhere herein.

In a first aspect, the data set is based at least in part on sampling of one or more reference signals

In a second aspect, alone or in combination with the first aspect, transmitting the compressed data set to the base station includes transmitting channel state information feedback to the base station.

In a third aspect, alone or in combination with one or more of the first and second aspects, process 1400 includes identifying the set of features of the data set, wherein the one or more extraction operations and compression operations includes a first type of operation performed in a dimension associated with a feature of the set of features of the data set, and a second type of operation, that is different from the first type of operation, performed in remaining dimensions associated with other features of the set of features of the data set.

In a fourth aspect, alone or in combination with one or more of the first through third aspects, the first type of operation includes a one-dimensional fully connected layer operation, and the second type of operation includes a convolution operation.

In a fifth aspect, alone or in combination with one or more of the first through fourth aspects, the one or more extraction operations and compression operations include multiple operations that include one or more of a convolution operation, a fully connected layer operation, or a residual neural network operation.

In a sixth aspect, alone or in combination with one or more of the first through fifth aspects, the one or more extraction operations and compression operations include a first extraction operation and a first compression operation performed for a first feature of the set of features of the data set, and a second extraction operation and a second compression operation performed for a second feature of the set of features of the data set.

In a seventh aspect, alone or in combination with one or more of the first through sixth aspects, process 1400 includes performing one or more additional operations on an intermediate data set that is output after performing the one or more extraction operations and compression operations.

In an eighth aspect, alone or in combination with one or more of the first through seventh aspects, the one or more additional operations include one or more of a quantization operation, a flattening operation, or a fully connected operation.

In a ninth aspect, alone or in combination with one or more of the first through eighth aspects, the set of features of the data set includes one or more of a spatial feature, or a tap domain feature.

In a tenth aspect, alone or in combination with one or more of the first through ninth aspects, the one or more extraction operations and compression operations include one or more of a spatial feature extraction using a one-dimensional convolution operation, a temporal feature extraction using a one-dimensional convolution operation, a residual neural network operation for refining an extracted spatial feature, a residual neural network operation for refining an extracted temporal feature, a pointwise convolution operation for compressing the extracted spatial feature, a pointwise convolution operation for compressing the extracted temporal feature, a flattening operation for flattening the extracted spatial feature, a flattening operation for flattening the extracted temporal feature, or a compression operation for compressing one or more of the extracted temporal feature or the extracted spatial feature into a low dimension vector for transmission.

In an eleventh aspect, alone or in combination with one or more of the first through tenth aspects, the one or more extraction operations and compression operations include a first feature extraction operation associated with one or more features that are associated with a base station, a first compression operation for compressing the one or more features that are associated with the base station, a second feature extraction operation associated with one or more features that are associated with the UE, and a second compression operation for compressing the one or more features that are associated with the UE.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a base station, in accordance with the present disclosure. Example process 1500 is an example where the second device (e.g., a decoding device, base station 110 among other examples) performs operations associated with decoding a data set using a neural network.

As shown in FIG. 15, in some aspects, process 1500 may include receiving, from a first device, a compressed data set (block 1510). For example, the second device (e.g., using a reception component) may receive, from a first device, a compressed data set, as described above.

As further shown in FIG. 15, in some aspects, process 1500 may include decoding the compressed data set using one or more decompression operations and reconstruction operations associated with a neural network, the one or more decompression and reconstruction operations being based at least in part on a set of features of the compressed data set to produce a reconstructed data set (block 1520). For example, the second device (e.g., using a decoding component) may decode the compressed data set using one or more decompression operations and reconstruction operations associated with a neural network, the one or more decompression and reconstruction operations being based at least in part on a set of features of the compressed data set to produce a reconstructed data set, as described above.

Process 1500 may include additional aspects, such as any single aspect or any combination of aspects described below and/or in connection with one or more other processes described elsewhere herein.

In a first aspect, decoding the compressed data set using the one or more decompression operations and reconstruction operations includes performing the one or more decompression operations and reconstruction operations based at least in part on an assumption that the first device generated the compressed data set using a set of operations that are symmetric to the one or more decompression operations and reconstruction operations, or performing the one or more decompression operations and reconstruction operations based at least in part on an assumption that the first device generated the compressed data set using a set of operations that are asymmetric to the one or more decompression operations and reconstruction operations.

In a second aspect, alone or in combination with the first aspect, the compressed data set is based at least in part on sampling by the first device of one or more reference signals.

In a third aspect, alone or in combination with one or more of the first and second aspects, receiving the compressed data set includes receiving channel state information feedback from the first device.

In a fourth aspect, alone or in combination with one or more of the first through third aspects, the one or more decompression operations and reconstruction operations include a first type of operation performed in a dimension associated with a feature of the set of features of the compressed data set, and a second type of operation, that is different from the first type of operation, performed in remaining dimensions associated with other features of the set of features of the compressed data set.

In a fifth aspect, alone or in combination with one or more of the first through fourth aspects, the first type of operation includes a one-dimensional fully connected layer operation, and wherein the second type of operation includes a convolution operation.

In a sixth aspect, alone or in combination with one or more of the first through fifth aspects, the one or more decompression operations and reconstruction operations include multiple operations that include one or more of a convolution operation, a fully connected layer operation, or a residual neural network operation.

In a seventh aspect, alone or in combination with one or more of the first through sixth aspects, the one or more decompression operations and reconstruction operations include a first operation performed for a first feature of the set of features of the compressed data set, and a second operation performed for a second feature of the set of features of the compressed data set.

In an eighth aspect, alone or in combination with one or more of the first through seventh aspects, process 1500 includes performing a reshaping operation on the compressed data set.

In a ninth aspect, alone or in combination with one or more of the first through eighth aspects, the set of features of the compressed data set include one or more of a spatial feature, or a tap domain feature.

In a tenth aspect, alone or in combination with one or more of the first through ninth aspects, the one or more decompression operations and reconstruction operations include one or more of a feature decompression operation, a temporal feature reconstruction operation, or a spatial feature reconstruction operation.

In an eleventh aspect, alone or in combination with one or more of the first through tenth aspects, the one or more decompression operations and reconstruction operations include a first feature reconstruction operation performed for one or more features associated with the first device, and a second feature reconstruction operation performed for one or more features associated with the second device.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a second device, in accordance with the present disclosure. Example process 1600 is an example where the second device (e.g., base station 110, apparatus 1106, among other examples) performs operations associated with power control for channel state feedback processing.

As shown in FIG. 16, in some aspects, process 1600 may include receiving first channel state feedback processed using a first type of channel state feedback processing (block 1610). For example, the second device (e.g., using reception component 1702) may receive first channel state feedback processed using a first type of channel state feedback processing, as described above.

As further shown in FIG. 16, in some aspects, process 1600 may include receiving, after satisfaction of a power threshold, second channel state feedback processed using a second type of channel state feedback processing (block 1620). For example, the second device (e.g., using reception component 1702) may receive, after satisfaction of a power threshold, second channel state feedback processed using a second type of channel state feedback processing, as described above.

Process 1600 may include additional aspects, such as any single aspect or any combination of aspects described below and/or in connection with one or more other processes described elsewhere herein.

In a first aspect, process 1600 includes decoding the first channel state feedback based at least in part on the first channel state feedback processing type, and decoding the second channel state feedback based at least in part on the second channel state feedback processing type.

In a second aspect, alone or in combination with the first aspect, at least one of the first channel state feedback or the second channel state feedback includes Type-I channel state information, Type-II channel state information, Type-III channel state information, or a combination thereof.

In a third aspect, alone or in combination with one or more of the first and second aspects, the first type of channel state feedback processing is a first type of neural network processing with a first architecture.

In a fourth aspect, alone or in combination with one or more of the first through third aspects, the second type of channel state feedback processing is a second type of neural network processing with a second architecture.

In a fifth aspect, alone or in combination with one or more of the first through fourth aspects, the second type of channel state feedback processing is a non-neural network type of processing.

In a sixth aspect, alone or in combination with one or more of the first through fifth aspects, process 1600 includes transmitting signaling identifying a configuration for channel state feedback processing switching to cause a first device to transition to using the second type of channel state feedback processing as a response to the satisfaction of the power threshold .

In a seventh aspect, alone or in combination with one or more of the first through sixth aspects, the signaling includes radio resource control signaling, downlinking control information signaling, medium access control control element signaling, or a combination thereof.

In an eighth aspect, alone or in combination with one or more of the first through seventh aspects, the configuration for channel state feedback processing switching includes information identifying the power threshold, the first type of channel state feedback processing, the second type of channel state feedback processing, or a combination thereof.

In a ninth aspect, alone or in combination with one or more of the first through eighth aspects, process 1600 includes receiving information identifying the second type of channel state feedback processing in connection with receiving the second channel state feedback.

In a tenth aspect, alone or in combination with one or more of the first through ninth aspects, the information identifying the second type of channel state feedback processing is included in a physical uplink control channel or a physical uplink shared channel.

In an eleventh aspect, alone or in combination with one or more of the first through tenth aspects, process 1600 includes receiving, after receiving the second channel state feedback, third channel state feedback processed using the first type of channel state feedback processing.

In a twelfth aspect, alone or in combination with one or more of the first through eleventh aspects, a transition from the second type of channel state feedback processing to the first type of channel state feedback processing is based at least in part on of a threshold period of time, satisfaction of the power threshold, satisfaction of another power threshold, a connection of a first device to a power source, or a combination thereof.

In a thirteenth aspect, alone or in combination with one or more of the first through twelfth aspects, process 1600 includes transmitting signaling configuring a transition from the second type of channel state feedback processing to the first type of channel state feedback processing .

In a fourteenth aspect, alone or in combination with one or more of the first through thirteenth aspects, process 1600 includes receiving information identifying the first type of channel state feedback processing in connection with receiving the third channel state feedback.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

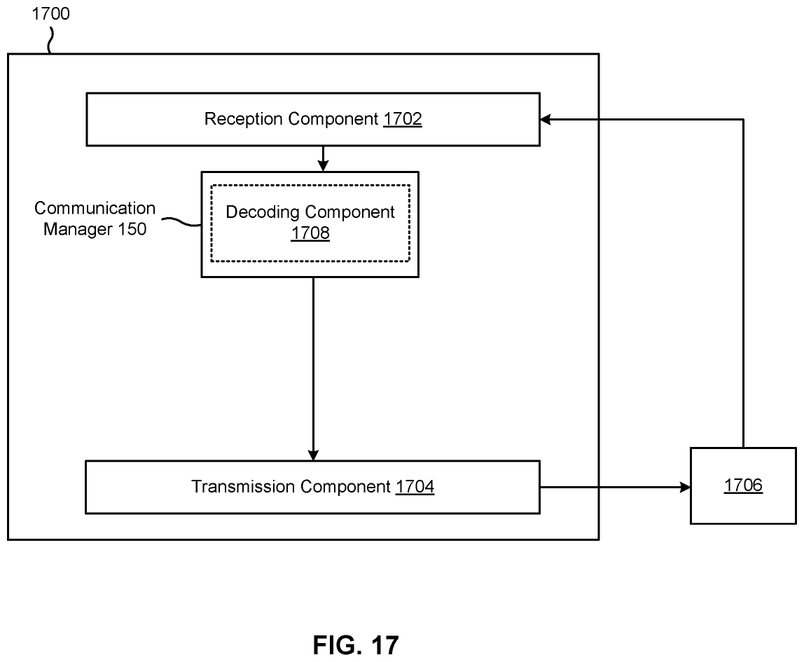

FIG. 17 is a block diagram of an example apparatus 1700 for wireless communication. The apparatus 1700 may be a second device (a decoding device, a BS, such as base station 110), or a second device may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a first device, which may be a UE or another wireless communication device) using the reception component 1702 and the transmission component 1704. As further shown, the apparatus 1700 may include a communication manager 150, that includes a decoding component 1708 among other examples.

In some aspects, the apparatus 1700 may be configured to perform one or more operations described herein in connection with FIG. 9. Additionally, or alternatively, the apparatus 1700 may be configured to perform one or more processes described herein, such as process 1600 of FIG. 16 among other examples. In some aspects, the apparatus 1700 and/or one or more components shown in FIG. 17 may include one or more components of the base station described above in connection with FIG. 2. Additionally, or alternatively, one or more components shown in FIG. 17 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. In some aspects, the reception component 1702 may channel state feedback, an identifier of a type of processing used to process channel state feedback, an indicator of a transition between channel state feedback processing types, among other examples. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1706. In some aspects, the reception component 1702 may include one or more antennas, a demodulator, a MIMO detector, a receive processor, a controller/processor, a memory, or a combination thereof, of the base station described above in connection with FIG. 2.

The transmission component 1704 may transmit communications, such as reference signals, control information, data communications, or a combination thereof, to the apparatus 1706. In some aspects, the transmission component 1704 may transmit information identifying a configuration for channel state feedback processing. In some aspects, one or more other components of the apparatus 1706 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modulator, a transmit MIMO processor, a transmit processor, a controller/processor, a memory, or a combination thereof, of the base station described above in connection with FIG. 2. In some aspects, the transmission component 1704 may be collocated with the reception component 1702 in a transceiver.

The decoding component 1708 may decode first channel state feedback processed using a first channel state feedback processing type, second channel state feedback processed using a second channel state feedback processing type, among other examples. In some aspects, the decoding component 1708 may include a receive processor, a transmit processor, a controller/processor, a memory, or a combination thereof, of the base station described above in connection with FIG. 2.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

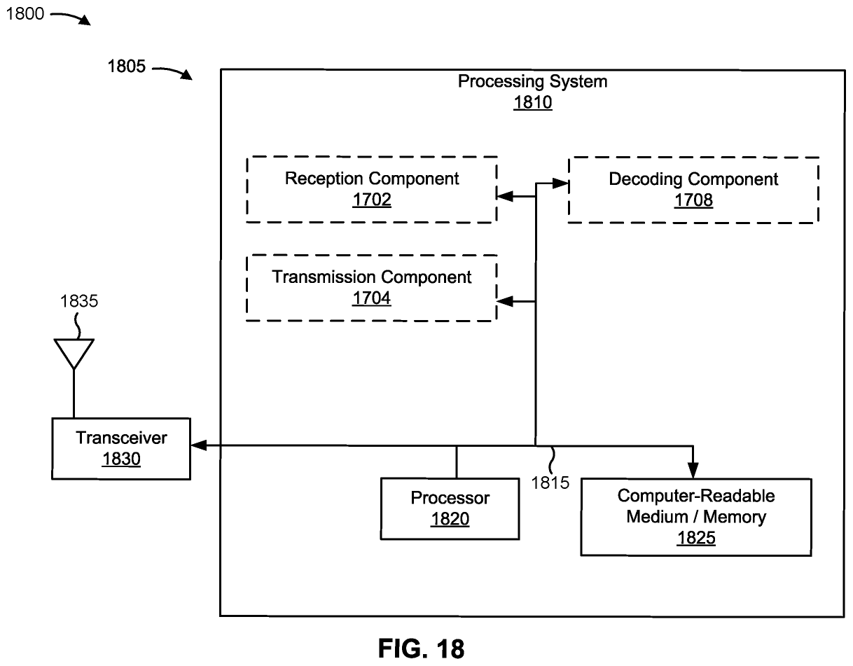

FIG. 18 is a diagram illustrating an example 1800 of a hardware implementation for an apparatus 1805 employing a processing system 1810. The apparatus 1805 may be a base station, such as base station 110.

The processing system 1810 may be implemented with a bus architecture, represented generally by the bus 1815. The bus 1815 may include any number of interconnecting buses and bridges depending on the specific application of the processing system 1810 and the overall design constraints. The bus 1815 links together various circuits including one or more processors and/or hardware components, represented by the processor 1820, the illustrated components, and the computer-readable medium/memory 1825. The bus 1815 may also link various other circuits, such as timing sources, peripherals, voltage regulators, power management circuits, and/or the like.

The processing system 1810 may be coupled to a transceiver 1830. The transceiver 1830 is coupled to one or more antennas 1835. The transceiver 1830 provides a means for communicating with various other apparatuses over a transmission medium. The transceiver 1830 receives a signal from the one or more antennas 1835, extracts information from the received signal, and provides the extracted information to the processing system 1810, specifically the reception component 1702. In addition, the transceiver 1830 receives information from the processing system 1810, specifically the transmission component 1704, and generates a signal to be applied to the one or more antennas 1835 based at least in part on the received information.

The processing system 1810 includes a processor 1820 coupled to a computer-readable medium/memory 1825. The processor 1820 is responsible for general processing, including the execution of software stored on the computer-readable medium/memory 1825. The software, when executed by the processor 1820, causes the processing system 1810 to perform the various functions described herein for any particular apparatus. The computer-readable medium/memory 1825 may also be used for storing data that is manipulated by the processor 1820 when executing software. The processing system further includes at least one of the illustrated components. The components may be software modules running in the processor 1820, resident/stored in the computer-readable medium/memory 1825, one or more hardware modules coupled to the processor 1820, or some combination thereof.

In some aspects, the processing system 1810 may be a component of a base station 110 and may include the memory 242 and/or at least one of the transmit processor 220, the RX processor 238, and/or the controller/processor 240. In some aspects, the apparatus 1805 for wireless communication includes means for receiving first channel state feedback processed using a first type of channel state feedback processing, means for receiving second channel state feedback processed using a second type of channel state feedback processing, means for decoding the first channel state feedback, means for decoding the second channel state feedback, means for transmitting information identifying a configuration for channel state feedback processing and/or transitioning, among other examples.

The aforementioned means may be one or more of the aforementioned components of the apparatus 1700 and/or the processing system 1810 of the apparatus 1805 configured to perform the functions recited by the aforementioned means. As described elsewhere herein, the processing system 1810 may include the TX processor 220, the RX processor 238, and/or the controller/processor 240. In one configuration, the aforementioned means may be the TX processor 220, the RX processor 238, and/or the controller/processor 240 configured to perform the functions and/or operations recited herein.

FIG. 18 is provided as an example. Other examples may differ from what is described in connection with FIG. 18.

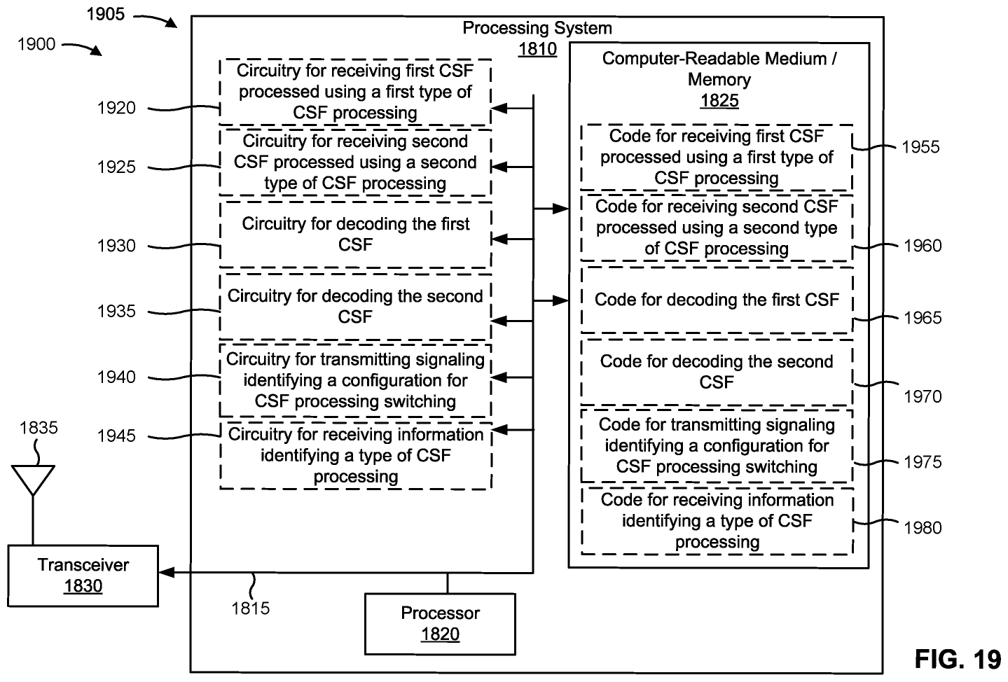

FIG. 19 is a diagram illustrating an example 1900 of an implementation of code and circuitry for an apparatus 1905. The apparatus 1905 may be a base station, such as base station 110 among other examples.

As further shown in FIG. 19, the apparatus may include circuitry for receiving first channel state feedback processed using a first type of channel state feedback processing (circuitry 1920). For example, the apparatus may include circuitry to enable the apparatus to receive first channel state feedback processed using a first type of channel state feedback processing.

As further shown in FIG. 19, the apparatus may include circuitry for receiving second channel state feedback processed using a second type of channel state feedback processing (circuitry 1925). For example, the apparatus may include circuitry to enable the apparatus to receive second channel state feedback processed using a second type of channel state feedback processing.

As further shown in FIG. 19, the apparatus may include circuitry for decoding the first channel state feedback (circuitry 1930). For example, the apparatus may include circuitry to enable the apparatus to decode the first channel state feedback.

As further shown in FIG. 19, the apparatus may include circuitry for decoding the second channel state feedback (circuitry 1935). For example, the apparatus may include circuitry to enable the apparatus to decode the second channel state feedback.

As further shown in FIG. 19, the apparatus may include circuitry for transmitting signaling identifying a configuration for channel state feedback processing switching (circuitry 1940). For example, the apparatus may include circuitry to enable the apparatus to transmit signaling identifying a configuration for channel state feedback processing switching.

As further shown in FIG. 19, the apparatus may include circuitry for receiving information identifying a type of channel state feedback processing (circuitry 1945). For example, the apparatus may include circuitry to enable the apparatus to receive information identifying a type of channel state feedback processing.

As further shown in FIG. 19, the apparatus may include, stored in computer-readable medium 1825, code for receiving first channel state feedback processed using a first type of channel state feedback processing (code 1955). For example, the apparatus may include code that, when executed by the processor 1820, may cause the transceiver 1830 to receive first channel state feedback processed using a first type of channel state feedback processing.

As further shown in FIG. 19, the apparatus may include, stored in computer-readable medium 1825, code for receiving second channel state feedback processed using a second type of channel state feedback processing (code 1960). For example, the apparatus may include code that, when executed by the processor 1820, may cause the transceiver 1830 to receive second channel state feedback processed using a second type of channel state feedback processing.

As further shown in FIG. 19, the apparatus may include, stored in computer-readable medium 1825, code for decoding the first channel state feedback (code 1965). For example, the apparatus may include code that, when executed by the processor 1820, may cause the processor 1820 to decode the first channel state feedback.

As further shown in FIG. 19, the apparatus may include, stored in computer-readable medium 1825, code for decoding the second channel state feedback (code 1970). For example, the apparatus may include code that, when executed by the processor 1820, may cause the processor 1820 to decode the second channel state feedback.

As further shown in FIG. 19, the apparatus may include, stored in computer-readable medium 1825, code for transmitting signaling identifying a configuration channel state feedback processing switching (code 1975). For example, the apparatus may include code that, when executed by the processor 1820, may cause the transceiver 1830 to transmit signaling identifying a configuration channel state feedback processing switching.

As further shown in FIG. 19, the apparatus may include, stored in computer-readable medium 1825, code for receiving information identifying a type of channel state feedback processing (code 1980). For example, the apparatus may include code that, when executed by the processor 1820, may cause the transceiver 1830 to receive information identifying a type of channel state feedback processing.

FIG. 19 is provided as an example. Other examples may differ from what is described in connection with FIG. 19.

The following provides an overview of some Aspects of the present disclosure:

Aspect 1: A method of wireless communication performed by a first device, comprising: determining that a power threshold for the first device is satisfied; and transitioning from a first type of channel state feedback processing to a second type of channel state feedback processing based at least in part on determining that the power threshold for the first device is satisfied.

Aspect 2: The method of Aspect 1, further comprising: transmitting, before determining that the power threshold for the first device is satisfied, first channel state feedback processed using the first type of channel state feedback processing; and transmitting, after transitioning from the first type of channel state feedback processing to the second type of channel state feedback processing, second channel state feedback processed using the second type of channel state feedback processing.

Aspect 3: The method of any of Aspects 1 to 2, further comprising: determining channel state information, for reporting, using the second type of channel state feedback processing based at least in part on transitioning from the first type of channel state feedback processing to the second type of channel state feedback processing.

Aspect 4: The method of any of Aspects 1 to 3, wherein at least one of the first type of channel state feedback processing or the second type of channel state feedback processing includes generating: Type-I channel state information, Type-II channel state information, Type-III channel state information, or a combination thereof.

Aspect 5: The method of any of Aspects 1 to 4, wherein the first type of channel state feedback processing is a first type of neural network processing with a first architecture.

Aspect 6: The method of Aspect 5, wherein the second type of channel state feedback processing is a second type of neural network processing with a second architecture.

Aspect 7: The method of Aspect 5, wherein the second type of channel state feedback processing is a non-neural network type of processing.

Aspect 8: The method of any of Aspects 1 to 7, further comprising: receiving signaling identifying a configuration for channel state feedback processing switching; and wherein transitioning from the first type of channel state feedback processing to the second type of channel state feedback processing comprises: transitioning from the first type of channel state feedback processing to the second type of channel state feedback processing based at least in part on the configuration for channel state feedback processing switching.

Aspect 9: The method of Aspect 8, wherein the signaling includes: radio resource control signaling, downlink control information signaling, medium access control (MAC) control element (CE) signaling, or a combination thereof.

Aspect 10: The method of any of Aspects 8 to 9, wherein the configuration for channel state feedback processing switching includes information identifying: the power threshold, the first type of channel state feedback processing, the second type of channel state feedback processing, or a combination thereof.

Aspect 11: The method of any of Aspects 1 to 10, wherein the power threshold is a first device-defined threshold.

Aspect 12: The method of any of Aspects 1 to 11, further comprising: transmitting information identifying the second type of channel state feedback processing based at least in part on transitioning from the first type of channel state feedback processing to the second type of channel state feedback processing.

Aspect 13: The method of Aspect 12, wherein the information identifying the second type of channel state feedback processing is included in a physical uplink control channel or a physical uplink shared channel.

Aspect 14: The method of any of Aspects 1 to 13, further comprising: transitioning, after transitioning to the second type of channel state feedback processing, from the second type of channel state feedback processing to the first type of channel state feedback processing.

Aspect 15: The method of Aspect 14, wherein the transitioning to the first type of channel state feedback processing is based at least in part on: expiration of a threshold period of time, satisfaction of the power threshold, satisfaction of another power threshold, a connection of the first device to a power source, or a combination thereof.

Aspect 16: The method of any of Aspects 14 to 15, wherein the transitioning to the first type of channel state feedback processing is based at least in part on: received signaling configuring the transition to the first type of channel state feedback processing, a first device determination of a satisfaction of a switching criterion, or a combination thereof.

Aspect 17: The method of any of Aspects 14 to 16, further comprising: transmitting information identifying the first type of channel state feedback processing based at least in part on transitioning to the first type of channel state feedback processing.

Aspect 18: A method of wireless communication performed by a second device, comprising: receiving first channel state feedback processed using a first type of channel state feedback processing; and receiving, after satisfaction of a power threshold, second channel state feedback processed using a second type of channel state feedback processing.

Aspect 19: The method of Aspect 18, further comprising: decoding the first channel state feedback based at least in part on the first channel state feedback processing type; and decoding the second channel state feedback based at least in part on the second channel state feedback processing type.

Aspect 20: The method of any of Aspects 18 to 19, wherein at least one of the first channel state feedback or the second channel state feedback includes: Type-I channel state information, Type-II channel state information, Type-III channel state information, or a combination thereof.

Aspect 21: The method of any of Aspects 18 to 20, wherein the first type of channel state feedback processing is a first type of neural network processing with a first architecture.

Aspect 22: The method of Aspect 21, wherein the second type of channel state feedback processing is a second type of neural network processing with a second architecture.

Aspect 23: The method of Aspect 21, wherein the second type of channel state feedback processing is a non-neural network type of processing.

Aspect 24: The method of any of Aspects 18 to 23, further comprising: transmitting signaling identifying a configuration for channel state feedback processing switching to cause a first device to transition to using the second type of channel state feedback processing as a response to the satisfaction of the power threshold.

Aspect 25: The method of Aspect 24, wherein the signaling includes: radio resource control signaling, downlink control information signaling, medium access control (MAC) control element (CE) signaling, or a combination thereof.

Aspect 26: The method of any of Aspects 24 to 25, wherein the configuration for channel state feedback processing switching includes information identifying: the power threshold, the first type of channel state feedback processing, the second type of channel state feedback processing, or a combination thereof.

Aspect 27: The method of any of Aspects 18 to 26, further comprising: receiving information identifying the second type of channel state feedback processing in connection with receiving the second channel state feedback.

Aspect 28: The method of Aspect 27, wherein the information identifying the second type of channel state feedback processing is included in a physical uplink control channel or a physical uplink shared channel.

Aspect 29: The method of any of Aspects 18 to 28, further comprising: receiving, after receiving the second channel state feedback, third channel state feedback processed using the first type of channel state feedback processing.

Aspect 30: The method of Aspect 29, wherein a transition from the second type of channel state feedback processing to the first type of channel state feedback processing is based at least in part on: expiration of a threshold period of time, satisfaction of the power threshold, satisfaction of another power threshold, a connection of a first device to a power source, or a combination thereof.

Aspect 31: The method of any of Aspects 29 to 30, further comprising: transmitting signaling configuring a transition from the second type of channel state feedback processing to the first type of channel state feedback processing.

Aspect 32: The method of any of Aspects 29 to 31, further comprising: receiving information identifying the first type of channel state feedback processing in connection with receiving the third channel state feedback.

Aspect 33: An apparatus for wireless communication at a device, comprising a processor; memory coupled with the processor; and instructions stored in the memory and executable by the processor to cause the apparatus to perform the method of one or more of Aspects 1-17.

Aspect 34: A device for wireless communication, comprising a memory and one or more processors coupled to the memory, the one or more processors configured to perform the method of one or more of Aspects 1-17.

Aspect 35: An apparatus for wireless communication, comprising at least one means for performing the method of one or more of Aspects 1-17.

Aspect 36: A non-transitory computer-readable medium storing code for wireless communication, the code comprising instructions executable by a processor to perform the method of one or more of Aspects 1-17.

Aspect 37: A non-transitory computer-readable medium storing a set of instructions for wireless communication, the set of instructions comprising one or more instructions that, when executed by one or more processors of a device, cause the device to perform the method of one or more of Aspects 1-17.

Aspect 38: An apparatus for wireless communication at a device, comprising a processor; memory coupled with the processor; and instructions stored in the memory and executable by the processor to cause the apparatus to perform the method of one or more of Aspects 18-32.

Aspect 39: A device for wireless communication, comprising a memory and one or more processors coupled to the memory, the one or more processors configured to perform the method of one or more of Aspects 18-32.

Aspect 40: An apparatus for wireless communication, comprising at least one means for performing the method of one or more of Aspects 18-32.

Aspect 41: A non-transitory computer-readable medium storing code for wireless communication, the code comprising instructions executable by a processor to perform the method of one or more of Aspects 18-32.

Aspect 42: A non-transitory computer-readable medium storing a set of instructions for wireless communication, the set of instructions comprising one or more instructions that, when executed by one or more processors of a device, cause the device to perform the method of one or more of Aspects 18-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a first device, comprising:
determining that a power threshold for the first device is satisfied; and
transitioning from a first type of channel state feedback processing to a second type of channel state feedback processing based at least in part on determining that the power threshold for the first device is satisfied.

2. The method of claim 1, further comprising:
transmitting, before determining that the power threshold for the first device is satisfied, first channel state feedback processed using the first type of channel state feedback processing; and
transmitting, after transitioning from the first type of channel state feedback processing to the second type of channel state feedback processing, second channel state feedback processed using the second type of channel state feedback processing.

3. The method of claim 1, further comprising:
determining channel state information, for reporting, using the second type of channel state feedback processing based at least in part on transitioning from the first type of channel state feedback processing to the second type of channel state feedback processing.

4. The method of claim 1, wherein at least one of the first type of channel state feedback processing or the second type of channel state feedback processing includes generating:
Type-I channel state information,
Type-II channel state information,
Type-III channel state information, or
a combination thereof.

5. The method of claim 1, wherein the first type of channel state feedback processing is a first type of neural network processing with a first architecture.

6. The method of claim 5, wherein the second type of channel state feedback processing is a second type of neural network processing with a second architecture.

7. The method of claim 5, wherein the second type of channel state feedback processing is a non-neural network type of processing.

8. The method of claim 1, further comprising:
receiving signaling identifying a configuration for channel state feedback processing switching; and
wherein transitioning from the first type of channel state feedback processing to the second type of channel state feedback processing comprises:
transitioning from the first type of channel state feedback processing to the second type of channel state feedback processing based at least in part on the configuration for channel state feedback processing switching.

9. The method of claim 8, wherein the signaling includes:
radio resource control signaling,
downlink control information signaling,
medium access control (MAC) control element (CE) signaling, or
a combination thereof.

10. The method of claim 8, wherein the configuration for channel state feedback processing switching includes information identifying:
the power threshold,
the first type of channel state feedback processing,
the second type of channel state feedback processing, or
a combination thereof.

11. The method of claim 1, wherein the power threshold is a first device-defined threshold.

12. The method of claim 1, further comprising:
transmitting information identifying the second type of channel state feedback processing based at least in part on transitioning from the first type of channel state feedback processing to the second type of channel state feedback processing.

13. The method of claim 12, wherein the information identifying the second type of channel state feedback processing is included in a physical uplink control channel or a physical uplink shared channel.

14. The method of claim 1, further comprising:
transitioning, after transitioning to the second type of channel state feedback processing, from the second type of channel state feedback processing to the first type of channel state feedback processing.

15. The method of claim 14, wherein the transitioning to the first type of channel state feedback processing is based at least in part on:
expiration of a threshold period of time,
satisfaction of the power threshold,
satisfaction of another power threshold,
a connection of the first device to a power source, or
a combination thereof.

16. The method of claim 14, wherein the transitioning to the first type of channel state feedback processing is based at least in part on:
received signaling configuring the transition to the first type of channel state feedback processing,
a first device determination of a satisfaction of a switching criterion, or
a combination thereof.

17. The method of claim 14, further comprising:
transmitting information identifying the first type of channel state feedback processing based at least in part on transitioning to the first type of channel state feedback processing.

18. A first device for wireless communication, comprising:
a memory; and
one or more processors coupled to the memory, the memory and the one or more processors configured to:
determine that a power threshold for the first device is satisfied; and
transition from a first type of channel state feedback processing to a second type of channel state feedback processing based at least in part on determining that the power threshold for the first device is satisfied.

19. The first device of claim 18, wherein the memory and the one or more processors are further configured to:
transmit, before determining that the power threshold for the first device is satisfied, first channel state feedback processed using the first type of channel state feedback processing; and
transmit, after transitioning from the first type of channel state feedback processing to the second type of channel state feedback processing, second channel state feedback processed using the second type of channel state feedback processing.

20. A method of wireless communication performed by a second device, comprising:
receiving first channel state feedback processed using a first type of channel state feedback processing; and
receiving, after satisfaction of a power threshold, second channel state feedback processed using a second type of channel state feedback processing.

21. The method of claim 20, further comprising:
decoding the first channel state feedback based at least in part on the first channel state feedback processing type; and
decoding the second channel state feedback based at least in part on the second channel state feedback processing type.

22. The method of claim 20, wherein at least one of the first channel state feedback or the second channel state feedback includes:
Type-I channel state information,
Type-II channel state information,
Type-III channel state information, or
a combination thereof.

23. The method of claim 20, wherein the first type of channel state feedback processing is a first type of neural network processing with a first architecture.

24. The method of claim 23, wherein the second type of channel state feedback processing is a second type of neural network processing with a second architecture.

25. The method of claim 23, wherein the second type of channel state feedback processing is a non-neural network type of processing.

26. The method of claim 20, further comprising:
transmitting signaling identifying a configuration for channel state feedback processing switching to cause a first device to transition to using the second type of channel state feedback processing as a response to the satisfaction of the power threshold.

27. The method of claim 26, wherein the signaling includes:
radio resource control signaling,
downlink control information signaling,
medium access control (MAC) control element (CE) signaling, or
a combination thereof.

28. The method of claim 26, wherein the configuration for channel state feedback processing switching includes information identifying:
the power threshold,
the first type of channel state feedback processing,
the second type of channel state feedback processing, or
a combination thereof.

29. A second device for wireless communication, comprising:
a memory; and
one or more processors coupled to the memory, the memory and the one or more processors configured to:
receive first channel state feedback processed using a first type of channel state feedback processing; and
receive, after satisfaction of a power threshold, second channel state feedback processed using a second type of channel state feedback processing.

30. The second device of claim 29, wherein the one or more processors are further configured to:
decode the first channel state feedback based at least in part on the first channel state feedback processing type; and
decode the second channel state feedback based at least in part on the second channel state feedback processing type.
